(19) United States
(12) Patent Application Publication
(10) Pub. No.: US 2002/0034162 A1
(43) Pub. Date: Mar. 21, 2002

(54) Technique for implementing fractional interval times for fine granularity bandwidth allocation

(76) Inventors: Kenneth W. Brinkerhoff, Mission Viejo, CA (US); Wayne P. Boese, Costa Mesa, CA (US); Robert C. Hutchins, Mission Viejo, CA (US); Stanley Wong, Santa Ana, CA (US)

Correspondence Address: BEYER WEAVER & THOMAS LLP, P.O. BOX 778, BERKELEY, CA, 94704-0778, US

(21) Appl. No.: 09/896,418

(22) Filed: Jun. 28, 2001

Related U.S. Application Data
(60) Provisional application No. 60/215,558, filed on Jun. 30, 2000.

(51) Int. Cl. H04J 1/16; H04J 3/14

(52) U.S. Cl. 370/229; 370/230; 370/235

(57) ABSTRACT

A technique is disclosed for scheduling data parcels from at least one client process to be output for transmission over a first communication line having an associated first bit rate. The at least one client process may include a plurality of client processes, each having a respective, associated bit rate. A plurality of data parcels associated with the client processes are identified by a scheduler. The scheduler performs scheduling operations and selects specific client data parcels to be included in an output stream provided to physical layer logic for transmission over the first communication line. An appropriate ratio of “filler” data parcels to be inserted into the output stream is determined. The “filler” data parcels correspond to disposable data parcels which do not include meaningful data. The output stream generated by the scheduler may include a uniform pattern of client data parcels (e.g. data parcels originating from the client processes) and “filler” data parcels. Additionally, according to specific embodiments, the scheduler is devoid of an internal clock source, and may perform scheduling operations based upon ratios of client and “filler” data parcels, rather than on an internal time base or reference signal.

### BACKGROUND OF THE INVENTION

A. Field of the Invention

The present invention relates to the communication of information by electrical or optical signals. More particularly, the invention relates to an integrated access device apparatus and method for accessing digital information signals transmitted in an Asynchronous Transfer Mode (ATM), and for converting voice, video and data information to ATM signals for transmission.

B. Description of Background Art

Enterprises such as private companies, learning institutions, health care organizations and governmental agencies routinely must transfer information in a substantially instantaneous or “real time” fashion between locations which are too far apart to permit face-to-face contact. Such information transfers include voice and telefacsimile transmissions over existing telephone communication channels, digital data interchange between computers, including Internet communications, and video conferencing.

Many enterprises also utilize a network of computer work stations located in individual offices or cubicles, which are interconnected with each other and sometimes with a larger computer which functions as a Server for the network. A Server typically has substantially greater memory storage and/or computational power than individual PCs (Personal Computers) located at employee work stations, and thus is often an expedient economic choice because the greater processing and memory capabilities of the Server, with the concomitant increases in size, power consumption and cost that these increased capabilities entail, need not be replicated in each work station PC.

A variety of network interconnection configurations, or topologies are employed in the interconnection of computers at a given enterprise site. Such networks are frequently referred to as Local Area Networks or LANs because of the relatively close geographic proximity of the interconnected computers. A popular interconnection standard and data exchange protocol for LANs is referred to as the Ethernet.

LANs as described above may be linked together to form a higher level, i.e., more broadly inclusive, network connecting geographically separated offices in a city, in a Metropolitan Area Network (MAN). MANs can be linked together to form a Wide Area Network (WAN), which might stretch nationwide, or to a worldwide network or Global Area Network (GAN), such as the Internet.

Existing telephone communication lines which link telephones world-wide employ a hierarchical interconnection scheme similar to that used between LANs at the user-end, node or “Edge” at one end of a network, and the GAN spanning the globe at the other end. Thus, enterprise sites are frequently equipped with Private Branch Exchanges (PBXs) that interconnect telephones and enable telephone communications between employees at a particular site. Telephones within the PBX may be connected to other sites in the same metropolitan area by a local Public Service Telephone Network (PSTN) carrier. The latter in turn may be interconnected to other metropolitan areas within a country by long distance or Wide Area telecommunications networks, which are in turn connected by communication channels operated by international carriers into a global telecommunication network.

Although the PSTN telecommunication network was originally designed to carry analog voice communications requiring only a bandwidth of about 4000 Hz for each conversation, telecommunication carriers learned early in the history of telephony that significant cost savings could be achieved by combining several telephone conversations and transmitting them over a single transmission channel, consisting of a single wire pair, for example. The process of combining multiple information signals such as those in multiple telephone conversations is referred to as multiplexing, while the process of recovering individual conversations from a common carrier signal and directing them to the proper destination telephone is called de-multiplexing.

While there are a variety of multiplexing and de-multiplexing techniques available, a method which is presently used most widely in the telecommunications industry is called Time Division Multiplexing (TDM). In TDM, analog information signals such as voice signals, are first digitized, i.e., converted into a stream of ones and zeros, or bits. The digital bits are then placed on a carrier signal such as an electrical current alternating at a frequency substantially greater than the maximum voice frequency which is to be transmitted, or on a laser beam, for example. This is done by modulating the carrier signal in unison with the sequential variations of ones and zeros in the information signal. Modulation consists of varying a characteristic such as the amplitude or phase of the carrier signal in unison with the variation in ones and zeros of the information signal. In Time Division Multiplexing, the string of ones or zeros, called Packets, representing a particular telephone conversation, are interleaved, “or time sequenced,” with packets of bits representing another telephone conversation, and transmitted on a common carrier signal. At the receiving end of the carrier signal, the packets of data representing the various conversations are split off from the other packets, converted into analog signals representing an original voice signal, and directed to the proper destination telephone.

Since PSTNs provide their typical subscribers with a telephone communication channel which has a bandwidth of 4 kHz, that channel may also be used to carry digital data signals, as long as the data bandwidth of the signals is within the allotted bandwidth. Thus, Modems (Modulators/Demodulators) are used to convert digital signals from telefacsimile machines and computers to packets of digital signals which may be transmitted over telephone lines. Accordingly, communications between individual computers and remote Internet sites are also routinely made over PSTN voice-quality lines. However, as can be readily understood, transmission of large amounts of data over reasonable time periods is frequently required by even modest sized enterprises. Therefore, telecommunications companies have made available wire or optical fiber communication lines which have a much greater bandwidth than ordinary voice grade telephone lines. For example, it is possible to rent T1 lines having a bandwidth of 1.544 Mbps (Megabits per second) in the United States, and E1 lines having a bandwidth of 2.048 Mbps in Europe. For enterprises requiring higher data transfer rates DSL (Digital Subscriber Lines) may be rented from the PSTNs, as can fiber optic lines having bandwidths ranging from several hundred Mbps, to several gigabits per second.

Not surprisingly, higher bandwidth communication lines are rented by the PSTNs at correspondingly higher prices. Moreover, as the following discussion will illustrate, the bandwidth requirements of even modest enterprise communications can be substantial. Thus, for example, a single voice grade digital telephone channel of the type connected to most residential telephones has a bandwidth of 64 Kbps (kilobits per record). This bandwidth requirement derives from the fact that ordinary voice communications, if they are to be transmitted with acceptable clarity and caller recognizability, must have, as stated earlier, a bandwidth of 4 Khz, if transmitted as an analog signal. However, as is well known, the Nyquist sampling criterion requires that an analog signal must be sampled at least twice the maximum frequency that is desired to reproduce. Accordingly, 4 Khz voice signals must be sampled at 2×4 Khz=8 Khz. Also, the dynamic range of voice signals required for acceptable communication has been determined to be about 256 to one, or 8 binary bits. Therefore, each digitized telephone connection channel must have a bandwidth of 64 Kbps. Thus, a T1 line, which at first glance would appear to have a substantially high bandwidth relative to that required for analog telephone conversations, can transmit only 24 digitized, TDM voice signals.

In addition to requiring substantial communication bandwidths for even modest numbers of telephone lines, most enterprises required substantially greater channel bandwidths for data interchange between enterprise sites and/or the Internet. Moreover, the increased use of video teleconferencing between various enterprise facilities requires even greater bandwidths. Thus, each time an additional group of telephones, new computer system, or video conferencing installation is added to an enterprise facility, it is generally required to procure additional communication lines from a PSTN service. This entails substantial capital investment and recurring costs, and the installation and connection of the new lines can disrupt enterprise operations.

In recognition of the problems resulting from increased communication channel bandwidths required by the burgeoning use of telephone, data, image and video transmissions by various enterprises, telecommunication experts have devised and implemented a mode of transmitting various signals of the foregoing type over a single communication channel. This technique is referred to as Asynchronous Transfer Mode.

To better understand ATM, and the novel advantages and benefits that the present invention contributes to ATM communications, it is perhaps useful to consider briefly data communication modes which preceded ATM. Thus, as described above, PSTN carriers transmit multiple voice signals over a single wire pair, optical fiber, satellite channel or the like, using time division multiplexing. In this communication mode, groups of individual bits, or packets, representing a single telephone conversation, for example, are interleaved in time with packets representing other conversations, into a single serial data stream. Typically, eight bits of information are grouped together in a serially arranged string to form an 8-bit Byte. Packets of bytes are then grouped together into a Frame, which adds a group of coding bytes called a header at the beginning of a data stream. Among other things, the header identifies the source and destination addresses of information or PAYLOAD bytes which follow the header, i.e., arrive later. The length of a frame is not specified, but may be limited by a PSTN carrier to a maximum value, one thousand bytes, for example.

Since the length of a Frame is indeterminate in some instances, a trailer must be placed at the end of each Frame, indicating that the immediately preceding byte was the last byte in a payload, and indicating source and destination addresses of the next packet of bytes. This method of grouping bytes together and identifying source and destination addresses, as well as other parameters related to the intended disposition of a data stream, is referred to as FRAME RELAY and is widely and effectively used in the telecommunication industry.

By communicating information packets in Frame Relay Frames, computer files may be interleaved with telephone conversations and transmitted in the Frames. This interleaving may be optimized by utilizing Statistical Time Division Multiplexing (STDM). In STDM, pauses in certain communications which would normally be encoded into data packets that convey no information are replaced by data packets bearing useful information from another telephone conversation, computer data file or the like. The STDM technique works well enough with Frame Relay for interleaving certain types of data traffic, such as telephone conversations and computer data files, because the unpredictable interruption and resumption of computer data transfer is usually of no concern, as long as all of the data bits eventually arrive at their destination at an acceptable overall or average data rate. However, other types of data may not readily be interleaved in a Frame Relay Frame. For example, while an occasional interruption of data flow, or variable delays in the arrival of data at a destination generally are not problematic in the transfer of computer data, such interruptions or delays can cause video images to tear or otherwise degrade in an unacceptable fashion. Also, voice communications which are delayed more than about 100 mseconds can be a source of annoyance to persons engaged in a conversation, and CD quality, high fidelity sound is perceptibly degraded by delays or Latency Periods much greater than about 100 microseconds. Thus, the disparate bandwidths and delay requirements of voice, digital data, video, image, and music are relatively hard to reconcile using Frame Relay Multiplexing of such signals, and this difficulty motivated, at least in part, the creation of the Asynchronous Transfer Mode (ATM).

In ATM, each packet of bits representing information is defined as a CELL which has a length fixed at 53 eight-bit bytes, or octets. The first 5 bytes of each cell comprise a header which contains, among other things, information related to the source and destination of the 48-byte-payload which immediately follows the header. Since each cell is exactly 53 bytes long, it is generally not necessary to have a trailer indicating the end of a payload. Also, the header of each ATM cell contains information related to which Virtual Channel (VC) within a Virtual Path (VP) that the cell is to travel. Moreover, the Virtual Channel and Virtual Path taken by each cell is specified by Virtual Path Identifier and Virtual Channel Identifier bits, respectively, in the header, causing the cell to travel over a channel specified to afford a particular Quality of Service (QoS), which will now be explained.

There are presently five QoS categories in ATM, ranging from one accorded the highest network priority, for which a PSTN or other carrier generally charges the most, to the lowest network priority, which is generally the least costly. The highest QoS category is Constant Bit Rate (CBR), which is contracted for between a user and telecommunication carrier for sensitive applications requiring a constant throughput rate with minimal cell delays or loss. Applications requiring CBR include PCM (Pulse Code Modulated) data streams carrying real-time voice, video, and circuit emulation of private lines or other TDM circuits. The quality of service or QoS category having the second highest network priority is Variable Bit Rate-Real Time (VBR-RT) and is used for information which must be transmitted at a fairly predictable rate, and which is sensitive to delay and loss.

QoS service category 3 is called Variable Bit-Rate, Non-Real Time (VBR-NRT), and is used for information which is less sensitive to delays. QoS category 4 is called Unspecified Bit Rate (UBR), and is used for applications in which substantial delay times are tolerable. QoS category 5 is called Available Bit Rate (ABR) and is used for transmitted information that is less critical than UBR data.

ATM has proven to be a highly efficient data transmission protocol, and has therefore been adopted by PSTNs and other telecommunication carriers world-wide. These carriers have invested heavily in converting hardware and software systems which formerly could work only with the Frame Relay protocol, to systems in which ATM format signals can be Interworked, or transformed into Frame Relay signals, and vice versa. Computers used to direct ATM data streams to the proper destination along wires, optical fibers or microwave carrier signals between ground stations or satellites are called Switches, and an ATM network whole is referred to as an ATM Backbone.

Devices which interconnect two or more networks are referred to as Bridges. Routers are devices which perform functions similar to those of Bridges, but function at a higher level. Thus, while a bridge knows the addresses of all the computers on each network joined together by the bridge, a Router also recognizes that other Bridges and Routers are on the network. Using that information, the Router is able to decide the most efficient path to send each message between a pair of end users. ATM networks may employ any of the devices described above.

A device of higher complexity than a Router exists, called a Gateway. The Gateway performs functions similar to that of a Router. However, in addition to routing functions, a Gateway is capable of translating or Interworking messages from one network format to the format of a different type of network. A Gateway can perform data format translations which enable data interchange between a LAN, such as an Ethernet LAN, and an ATM Backbone Network.

For an enterprise to fully exploit the advantages offered by ATM in achieving the goals of streamlining its communications while minimizing costs, it is usually necessary to have equipment on the enterprise site which enables the enterprise to connect its various systems to an ATM Backbone network. Such systems may include TDM voice signals from a PBX, video conferencing signals, Ethernet or other protocol LAN signals, among other types of data. ATM access equipment of this type are customarily referred to as Customer Premises Equipment (CPE), owing to the location of the equipment at an enterprise site. ATM CPEs provide a User to Network Interface (UNI), while interconnections between various nodes of an ATM network are called Netware Node Interfaces NNI).

There are presently available CPE devices which provide enterprises with access to an ATM Backbone network thus allowing the enterprise to bundle its communications links, including voice, data, video and the like, onto a common communication channel. However, there are a number of problems with existing CPE devices affording ATM access. Such problems have limited the full utilization of the advantages offered by ATM.

Although problems associated with the enterprise utilization of ATM are diverse, a main source of problems is the inherent complexity involved in the segmentation of data cells received from a stream source, and the reassembly of cells from diverse downstream sources such as PBXs, LANs, video cameras and the like, into a single ATM cell stream. Thus, while the stripping of different serial data flows from incoming ATM cells into individual data flow queues, and the interleaving of various outgoing cell queues into a single ATM cell stream may seem to be a relatively straight forward task, it in fact requires substantially great real-time computing power. Of course, if one had a super computer available which is dedicated to the task of performing ATM access functions such as those of a Router or Gateway, the computational portions of these task functions may be readily performed. However, the various types of interfaces typically required of an ATM access device would still be problematic, even if the exorbitant cost of a super computer could be discounted.

Because of the inherent complexity involved in performing various functions required of ATM access devices, present devices fall into general categories: (1) Versatile and very expensive devices using raw, high speed computational power afforded by general purposes processors, and (2) Moderately priced devices having limited capabilities.

The present invention was conceived of to provide an Integrated Access Device for Asynchronous Transfer Mode (ATM) Communications, which provides a wide variety of CPE UNI functions with substantially greater proficiency than existing devices, and at a substantially lower cost. The foregoing advantages are achieved by the novel combination of a RISC (Reduced Instruction Set) processor with a custom PLA (Programmable Logic Array) or ASIC (Application Specific Integrated Circuit) having a variety of performance enhancing imbedded algorithms.

### OBJECTS OF THE INVENTION

An object of the present invention is to provide an Integrated Access Device For Asynchronous Transfer Mode (ATM) Information communications, which provides bridging, routing, and interworking functions between ports selected from a group including ATM, Ethernet, Frame Relay, Voice, and Video signal technologies.

Another object of the invention is to provide an Integrated Access Device for ATM which converts incoming non-ATM signals to ATM signals, and imposes ATM QoS standards on the ATM signals, thus allowing ATM QoS to be imposed on signals which may be inputted and outputted as non-ATM signals.

Another object of the invention is to provide an Integrated Access Device for ATM which provides ATM switching and scheduling utilizing a RISC microprocessor which is operably interconnected with a hardware programmed gate array so as to minimize computational and memory requirements of the microprocessor.

Another object of the invention is to provide an Integrated Access Device for ATM which utilizes a microprocessor operatively interconnected with a Programmed Gate Array via a local bus, and a plurality of expansion ports connected to the programmed gate array via an expansion port bus, whereby input/output modules of various types may be plugged into any of the expansion ports.

Another object of the invention is to provide an Integrated Access Device for ATM which utilizes a single functional block which serves as a scheduler to fully service multiple qualities of service (QoS).

Another object of the invention is to provide an Integrated Access Device for ATM which contains a functional block that assigns a scheduler resource to multiple ports in correct proportions, with fine granularity in representing relative rates and intervals.

Another object of the invention is to provide an Integrated Access Device for ATM which contains a functional block including a beaded buffer pointer chain with intermediate pointers, thereby enabling multiple processes queues to be combined into a single flow queue.

Another object of the invention is to provide an Integrated Access Device for ATM which contains a functional block that provides capabilities of cut-through routing of data streams through the device.

Another object of the invention is to provide an Integrated Access Device for ATM which contains a functional block that provides multiple preemptive CBRs for Precise Port Pacing Control.

Another object of the invention is to provide an Integrated Access Device for ATM that includes a functional block comprising a partitionable page shifter with self-timing XOR chain.

Another object of the invention is to provide an Integrated Access Device for ATM which includes a functional block that provides cell output flow rates having fractional interval times for fine granularity bandwidth allocation.

Various other objects and advantages of the present invention, and its most novel features, will become apparent to those skilled in the art by perusing the accompanying specification, drawings and claims.

It is to be understood that although the invention disclosed herein is fully capable of achieving the objects and providing the advantages described, the characteristics of the invention described herein are merely illustrative of the preferred embodiments. Accordingly, we do not intend that the scope of our exclusive rights and privileges in the invention be limited to details of the embodiments described. We do intend that equivalents, adaptations and modifications of the invention reasonably inferable from the description contained herein be included within the scope of the invention as defined by the appended claims.

### SUMMARY OF THE INVENTION

The present invention is directed to an Integrated Access Device (IAD) supporting data and voice in the customer premise. The IAD is a 1U high chassis based product. A modular design will enable it to support several configurations.

The IAD main board contains all the circuitry and connectors for both the IAD application and the Fraim-IBM application and can be used in either product. The IAD is designed so that the form factor of the IAD main board is identical to the form factor of the Fraim-IBM CPU board.

The IAD is a functional bridge and IP router incorporating Ethernet, Frame Relay, ATM and voice technologies. With ATM switching and scheduling at its core, the IAD will fully support quality of service in ATM and be able to impose ATM QoS onto its non-ATM ports. It will support ATM PVC's and SVC's with UNI 3.0, 3.1 and 4.0 signaling. AAL-5 will be supported for data. The IAD will incorporate Frame Relay over ATM Interworking standards FRF.8 and FRF.5. AAL-1 and AAL-2 will be supported for voice. Both digital or analog voice will be supported.

The IAD can be modularized as shown in FIG. 1. The Main Board performs the core ATM switching and scheduling functions and Frame Relay to ATM Interworking. The Voice Processor performs voice compression and conversion of TDM voice channels to AAL-1 or AAL-2. The other modules provide physical interfaces.

The Main Board has four expansion ports that connect to IAD input/output modules. Three of these apply to the IAD application However, it can be supplied with fewer or more IAD input/output modules.

The present Integrated Access Device (IAD) advances the state of the art with architecture that achieves unprecedented levels of performance and economy in the delivery of broadband services to branch and regional offices. Specifically, the IAD allows incumbent and competitive access providers to deliver REAL T1 multiservice access at a relatively low price.

The IAD defines a new class of access CPE, which delivers high-end performance at pricing that enables carriers to broadly offer integrated services to the branch office market segment. This is possible because of the IAD architecture which is a protocol interworking hardware accelerator that enables new levels of multiservice network processing capability in an economical, scaleable architecture.

The Challenge in Public and Private Networks

The task of bringing multiservice access to branch and regional offices presents unique challenges for equipment manufacturers:

1. Cost of access bandwidth and equipment. On a per-Mbps basis, low-speed access bandwidth is most expensive in the network because it has not benefited from technology investments like optical networking the WAN or gigabit Ethernet in the LAN.

2. Limited bandwidth. The vast majority of branch offices are still served by cooper. Although DSL technologies have made tremendous strides in increasing the usable loop bandwidth, it remains limited to a few Mbps or less.

3. Price sensitivity, Branch and regional office access is the most price sensitive networking segment. Even though these services are part of a large corporate IT budget, every dollar spent for branch access is multiplied by the number of branches in the corporate network, making price an important discriminator.

4. Multiple communication protocols and traffic types. Branch office IADs must be able to interwork between many communication protocols: Frame Relay, Ethernet, ATM, Internet Protocol (IP), digital time-division multiplex (TDM) voice, analog voice, T1/E1, and xDSL. The complex translation process between these different protocols requires significant processor capabilities.

5. Limited networking expertise at end-user. The typical small, branch or regional office has little or no in-house networking expertise.

When the technical requirements placed on IADs—easily managed platform with support for multiple protocols, bandwidth maximizing capabilities and robust traffic management—are compared to the cost sensitivity of the branch office access market segment, it quickly becomes apparent that IADs present one of the most challenging design problems in networking.

In the past, access service providers could choose between two types of IADs for service deployment: high-end, high-performance equipment designed to scale to OC12 speeds, but not cost effective at T1 or multi-T1 speeds; or low-end, low-cost microprocessor-based equipment that have difficulty operating at wire speed when faced with a random mix of protocols.

A Better Solution

The IAD hardware-based networking processing accelerator specifically addresses the needs of the branch office access marketplace. The IAD hardware-based network processing accelerator operates in conjunction with a cost-effective RISC processor. Microprocessors are very effective in performing configuration and management functions but not efficient with highly repetitive data forwarding functions. The IAD hardware-based accelerator serves as the data forwarding engine, resulting in a high performance partnership. However, because the hardware-based accelerator is optimized for the branch office access challenge, it remains a very cost-effective solution.

At the core of the IAD hardware-based accelerator is an ATM switch and traffic shaper. This is surrounded by a protocol-interworking machine, allowing the hardware-based accelerator to adapt any type of traffic (TDM, IP, or Frame Relay, for instance) to ATM, apply ATM quality of service (QoS) to the traffic, then adapt it back into any other protocol. In this way, the hardware-based accelerator can provide any data flow with robust ATM QoS, even if the flow enters and exits the IAD in some other protocol.

The IAD performs various protocol tasks, like Ethernet bridging, IP routing, and Frame Relay-to-ATM interworking, while optimizing the traffic characteristics of the data flows. The tight coupling between the IAD hardware-based accelerator and the RISC processor also enables the IAD's performance to scale to meet the future needs of the branch office. The IAD applies ATM inverse multiplexing to aggregate several wideband links into a single braodband connection, allowing carriers to deliver more services over existing copper plant rather than waiting for a slow fiber build-out program. Alternative access providers (wireless local loop, point-to-point radio, digital cellular radio, etc.) can also take advantage of the IAD's IMA technology since it is transparent to the physical layer employed.

To take advantage of this protocol flexibility, the IAD can be built as a modular chassis, allowing carriers to customize the platform for their particular networks' and markets' needs, such as the following interfaces: Ethernet, synchronous serial, quad T1 ATM IMA, and digital T1 PBX interfaces.

In the modern networked enterprise, information technology must reach the most remote corner of the enterprise—however, this must be achieved without a similar deployment of network support personnel. The AID has been designed to meet these goals, including comprehensive remote management that allows configuration, monitoring and control without a truck-roll or site visit.

The IAD represents a major step forward in the provisioning of true broadband services to small, remote branch office locations.

For the customer, the IAD enables the realization of the true connected enterprise where discrimination based on location can become a thing of the past.

For the service provider, it allows them to capture the super-valuable business broadband service mark opportunity, without having to wait for fiber deployment.

For the alternative access provider, the IAD IMA technology, in combination with rapid-deployment wireless technologies, unlocks new opportunities. The IAD allows rapid capture of high-value business markets without the need for capital investment in fixed local loop transmission technologies.

The IAD represents a step change in opportunity. It opens new horizons in broadband deployment to the very edge of the enterprise or network by using the infrastructure which is already sitting in the ground—across the nation and the world.

Overview

The IAD of the present invention is an Integrated Access Device (IAD).

The IAD is a Customer Premises Equipment (CPE) solution that enables organizations to connect multiple branch offices economically to a multiservice ATM or Frame Relay Wide Area Network (WAN). It provides the means for branch end-users to combine their voice and data network connections on to a single low-speed network path, which can be more easily managed from the central headquarters.

The IAD connects to the customer's existing data, voice, and video equipment and resides in the end-user's communications room or closet. It is a sophisticated, branch-office, multiservice platform that provides many additional key functions and benefits over other CPE devices such as Frame Relay Access Devices (FRADs) or Time Division Multiplexers (TDMs).

The IAD can be configured as a host or CPE access device to provide:

1. Frame Relay to ATM interworking;

2. Inverse Multiplexing over ATM (IMA) for up to 4×E1/T1 lines;

3. Variable Bit Rate voice adaptation using AAL2 protocols;

4. Circuit Emulation Services using AAL1 protocols;

5. Comprehensive support for voice compression modulations;

6. Echo cancellation and silence suppression for AAL2 protocols;

7. Attachment to digital PBX using E1/T1 interfaces;

8. Analogue FXO (Foreign Exchange Office) and FXS (Foreign Exchange System) operation with Ground or Loop Start;

9. E&M (Electrical and Mechanical tie line) support for Types 1, 2, and 5 (Immediate, Delay, and Wink);

10. Support for voice, video, or data over single or multiple ISDN-BRI;

11. IP routing and bridging over ATM;

12. DHCP (Domain Host Configuration Protocol) and NAT (Network Address Translation) support;

13. Comprehensive support for SNMP network management;

14. Maximum of 4096 connections (FR DLCIs (Frame Relay Address), ATM VCs, etc.);

15. ATM PCR (Peak Cell Rate), SCR (Sustained Cell Rate), and MBS (Maximum Burst Size) traffic shaping;

16. ATM classes: CBR, VBR-rt, VBR-nrt, UBR and UBR+;

17. ATM PVCs and SVCs;

18. Per port pacing;

19. Frame Relay QoS via DLCI : CIR; and

20. Conformance to ATM and Frame Relay forum standards.

Interworking Technology

The IAD interworking solutions provide peer-to-peer connectivity between the IAD located in the branch offices and IADs located in the central or regional office locations. ATM or Frame Relay PVCs or are mapped according to networking requirements, which provide for a fully meshed configuration to exist between all IADs within a given Multiservice WAN.

Inverse Multiplexing over ATM

The IAD offers the capability of connecting up to 4×2 Mbps circuits into a logical IMA group, thus allowing ATM PVCs or SVCs to utilize available bandwidth fully. In this mode, the IAD connects to the ATM WAN switch via multiple 1.5 Mbps (T1) or 2 Mbps (E1) leased lines. The adjacent ATM switch must be configured with an equal IMA facility to terminate the logical group prior to core network switching of cell traffic, or the IMA group can be carried intact across the WAN to another IAD for termination.

Enhanced Voice Convergence

The IAD supports the multiplexing of compressed voice channels via ATM Adaptation Layer 2 (AAL2) protocols into a single ATM PVC or SVC, thus maximizing ATM bandwidth optimization. Further bandwidth efficiencies are obtained through utilizing silence suppression algorithms and local comfort noise generation to eliminate unnecessary cell transmissions. Additionally, the IAD supports uncompressed voice channel transmission via AAL1 structured Circuit Emulation Services (CES) to an adjacent IAD or other vendor equipment.

IP Routing and Bridging

The IAD offers unparalleled performance versus cost using its proprietary technology to perform frame to cell conversion and data forwarding in hardware. The IAD performs both local IP routing (RIPv1 & v2) and switching as well as ATM bridging using multi-protocol encapsulation techniques over AAL5 (RFC 1483 and RFC 1577 for Classical IP). The bridging function also supports the Spanning Tree protocol.

Frame Relay to ATM Interworking

Local data connections are managed via the IAD's Frame Relay to ATM Interworking function. This facility enables customers to retain their existing router hardware and software configurations to preserve access to legacy applications. The data connection operates up to 2 Mbps via a DB25 V.35X.21RS-530, or RS-449 interface. The interworking function supports either Network (FRF.5) or Service (FRF.8) Interworking in accordance with the Frame Relay Forum multi-protocol implementation agreements (RFC 1490

ATM Classes of Service

ATM PVCs and SVCsare fully supported to ATM UNI 3.0, 3.1, and 4.0 signaling. Quality of Service and traffic shaping per port is provided via VCC PCR, SCR, and MBS parameters. Service classes are supported via Adaptation Layers 1, 2, and 5 utilizing classes CBR, VBR-rt, VBR-nrt, UBR, and UBR+.

Advanced Network Management

The IAD provides extensive network management facilities via its internal SNMP agent and a supporting SNMP Network Management Application. A full range of functions is available to configure, monitor, and report upon network performance, configuration parameters, call management, fault management, and IP/Frame Relay network protocol statistics.

The IAD Management

Management of IAD is available through local and remote access to one or more IAD's via SNMP. The application is designed to provide the network management capabilities expected from enterprise or carrier-class customers. Network management is generally defined to encompass two main areas, namely Monitoring and Control. Preferably, the IAD management can be through Mariner Networks, Inc., Anaheim, Calif., Messenger™, SNMP Network Management Application which can provide local and remote access to one or more of the IAD's.

Network Monitoring is concerned with observing and analyzing the status and behavior of its network domain configuration and its devices.

Network Control is concerned with the altering of parameters of various configurations of the network devices and causing those components to perform predefined actions.

In line with this concept, IAD is a fully managed ATM IAD, which supports the following key disciplines:

1. Network Management,

2. Traffic Management,

3. Code Management,

4. Security Management.

Network Management

The IAD's subsystems can be managed in any of the following ways:

From an ASCII terminal with a character-based command line interface that is directly connected to the console monitor port.

By remotely logging into a command line interface via a Telnet session. This session may be via the local Ethernet port, Frame Relay port, or in-band across the ATM WAN.

By accessing the IAD's SNMP Agent via an authorized network management station, such as a station running Mariner Networks' SNMP Management Application “Messenger”. The network management station may reside anywhere in the network.

The IAD's Messenger™ application can be run on any type of network management workstation irrespective of operating system or machine type. It can be run under HP OpenView™ or independently, offering a complete network management environment for the enterprise or carrier class user. The graphical user interface (GUI) enables the operator to configure the IAD elements quickly and easily and to interrogate performance data and traffic profiles in a variety of tables and charts. Multiple IAD configurations and maps may be viewed simultaneously.

The IAD can support simultaneous access by multiple network management stations to facilitate redundancy and continuous network operational requirements. The SNMP agent can comprise Mariner Networks' Enterprise MIB and a number of industry compliant networking MIBs (ATM, FR, and MIB-II).

Traffic Management

The IAD's advanced traffic management functions include:

1. Priority queues per ATM Quality of Service (QoS),

2. Constant Bit Rate (CBR),

3. Real time Variable Bit Rate (VBR-rt),

4. Non-real time Variable Bit Rate (VBR-nrt),

5. Unspecified Bit Rate (UBR)

6. Unspecified Bit Rate Plus (UBR+), and

7. Traffic shaping per port and per Virtual Circuit (TM 4.0).

The IAD ensures that the Virtual Channel Connection (VCC) contract is respected at the Virtual Channel (VC) level. To reduce irregular bursts of traffic, a reshaping function is provided.

Code Management

Code management allows the network administrator or network operator to manage the application and user configuration modules contained within the IAD. The application module contains the program logic necessary for the IAD to function. User configuration modules consist of parameters and network definitions that describe the network, voice characteristics, profiles, and packet/cell routing information.

The IAD's flash memory can hold multiple copies of application modules as well as multiple copies of user configurations, and allows an operator to switch between them. In this way, the IAD can be reloaded or re-configured to perform differently while still retaining the ability to recover from updates that fail to function as required.

IAD's code management can be accessed in any of the following ways:

1. Application and user configuration module data can be uploaded or downloaded using TFTP (Trival File Transfer Protocol). The IAD contains a TFTP server that enables bi-directional processes.

2. Switching between application or user configuration data can be performed using either the console port via the command line interface (CLI), via a Telnet session, or remotely via the Management application.

3. Using the console monitor port, uploading and downloading of application or user configuration data can be performed.

Providing multiple copies of application and user configuration data in flash memory enhances the IAD's network manageability in a customer premises environment. The IAD's advanced network management capabilities enable network control and monitoring to be performed quickly and simply with the minimum of end-user involvement.

Security Management

The IAD can be configured with the following security features:

Configuration Protection

Access to the IAD via the console monitor port can be password protected to protect the IAD's configuration. This password can be changed at the customer's/end-user's discretion. A hardware-based reset feature can be incorporated to enable recovery to a default password in the event of password loss.

Network Access Protection

Telnet access to the IAD's Command Line Interface (CLI) via the ATM, local Ethernet or Frame Relay network is provided and access is controlled via a password.

Access to the IAD SNMP agent is controlled via a domain name to prevent and limit unauthorized use.

Typical Implementations

The IAD simplifies ATM access at the customer premises. This is achieved through implementing the IAD as an ATM Interworking Network Terminating Unit (NTU) that clearly defines the boundary of the ATM network from the customer's local network communications equipment. Through its ATM interworking capabilities, the IAD converges multiple services (voice, data, and video) over single or multiple upstream ATM links. FIG. 2 illustrates a typical configuration.

FIG. 11 illustrates a simple “mesh system” implemented between several office locations. All IADs are configured to establish PVCs (Permanent Virtual Circuits) between remote locations and to the central location housing the host system and application servers. Multiple IADs may be installed at the central location to provide sufficient voice channel capacity for head office personnel.

The IAD product can consist of a multi-slot, such as a 3-slot, chassis enclosure with the following components:

1. Main processor board with application software loaded,

2. Power supply assembly,

3. 1×RJ45 Ethernet port,

4. 1×DB9 RS-232 console monitor port, and

5. Three or more blank single-slot filler plates.

The following components can be furnished with the IAD to facilitate power up and initial configuration:

1. Power supply cord,

2. RS232 modem cable, and

3. Documentation CD-ROM package.

System Component

All IAD units are based upon a main processor board design and chassis enclosure that facilitates the insertion of one or more Network or User Interface Modules depending upon the number of available slots. The modules are described below.

The main processor board contains the CPU, various memory modules, operating system, and application code. Additionally, this board holds a switch processor, either a programmable logic device or an ASIC that performs frame to cell conversion and data forwarding in hardware.

The IAD can be equipped with a single RJ45 socket on the front panel system unit to facilitate either 10BaseT Ethernet or Telnet management access. In this way, the IAD can be configured without the need for any modules to be inserted prior to use. Initial configuration of IP (Internet Protocol) addressing would need to be achieved via the console monitor port.

The IAD is preferably equipped with the DB9 RS-232 female DCE connector unit to facilitate initial configuration of the IAD unit.

Main memory is provided in all IAD configurations. In addition to this memory offering, IAD is configured with flash memory to hold multiple application and user configuration data, and boot PROM to support initial power-on and program load functions. Sixteen (16) MB of DRAM memory can be used; more or less memory can be used.

Each unit is preferably configured with an internal auto-detecting VAC power supply with a fused power switch and a power cord.

A printed Quick Start Installation Guide is preferably provided with all IAD units. All other documentation relating to IAD is available on an accompanying CD-ROM or other memory device or on a website. Additionally, all user-related documentation is available by downloading from the Mariner Networks website.

Each IAD is fitted with a modem cable, such as an RS-232 DB9 DCE/DTE modem cable. Access to the console monitoring port is through a terminal device, such as a VT100 terminal device.

In addition to the base components supplied with the chassis, the IAD will need to be populated with one or more Network or User Interface Modules that connect the ATM WAN or the existing customer communications equipment.

The IAD is preferably designed to be either a standalone, wall-mounted, or rack-mounted unit. Mounting kits can be made available to facilitate the installation of the IAD into a 19 inch communications rack or onto a wall.

A number of cabling options are preferably supported to accommodate connection of the ATM interface, and Frame Relay V.35/X.21 attached router to the IAD.

The IAD can be supported by many types of network modules and user modules (interfaces) which can be adapted to be received in universal slots, i.e. slots that will accept modules of any type of interface protocol, or dedicated slots that will receive a more limited number of modules of specific types of interfaces protocols. Universal slots are preferred. A limited number of network and user modules are identified in Table 1.

Network Module

A 1×port T1/E1, or 4×port T1/E1 module can be provided.

Each module may be configured to operate in ATM cell delineation or Frame Relay HDLC delineation mode. Each interface can be presented as an RJ48C female socket that can accept either a T1 (1.5 Mbps) or an E1 (2 Mbps) facility interface.

Each module can have the following characteristics:

1. 1 or 4 ports each operating at either 1.544 Mbps or 2.048 Mbps line rate.

2. Each port may connect to an ATM switch via UNI (3.0, 3.1, or 4.0), or a Frame Relay DLCI compliant device.

3. Integrated CSU/DSU functionality.

4. Physical interface is electrical with impedance of 100/120 Ohms.

5. One or more modules may be inserted into the IAD depending upon the available slots.

6. Both modules are preferably easily swappable without the need for specialist knowledge or equipment. The IAD will probably require rebooting and reconfiguring upon change of module type.

FIG. 12 shows a 1×port T1/E1 and 4×port T1/E1 module face plates.

Network Module

A 4×port E1 or T1 module for ATM Inverse Multiplexing over ATM (IMA) network can be provided.

This module may be configured to operate in a variety of logical IMA line groups. Each interface can be presented as an RJ48C female socket that can accept either a T1 (1.5 Mbps) or E1 (2 Mbps) facility interface.

The module has the following characteristics:

1. 4 ports, each operating at either 1.544 Mbps or 2.048 Mbps line rate.

2. Each port may connect to an ATM switch via UNI (User Network Interface) using a supported interface.

3. T1 option has an integrated CSU/DSU (Channel Service Unit/Data Service Unit) functionality.

4. Physical interface is electrical with impedance of 100/120 Ohms.

5. One or more modules may be inserted into any of IAD's slots.

6. This module is preferably easily swappable without the need for specialist knowledge or equipment. IAD will probably require rebooting and reconfiguring upon change of module type.

FIG. 13 shows the faceplate of the module.

Network Module

A 1×port DS-3 or 1×port E3 network module for ATM DS-3/E3 network can be provided.

Each module can be configured to operate in ATM cell delineation mode. Each interface is preferably presented as a BNC 75 Ohm female connector that can accept either a DS-3 (45 Mbps) or an E3 (34 Mbps) facility interface.

Each module preferably has the following characteristics:

1. 1 port operating at 34 Mbps or 45 Mbps line rate.

2. Each port may connect to an ATM switch via UNI using a supported interface.

3. Physical interface is electrical with an impedance of 75 Ohms.

4. One or more modules may be inserted into any of the IAD's slots depending upon availability.

5. Both modules are preferably easily swappable without the need for specialist knowledge or equipment. IAD will probably require rebooting and reconfiguring upon change of module type.

FIG. 14 shows the faceplate of the module.

Network Module

A 1×port OC-3 or 1×port STM-1 for ATM OC-3/STM-1 network can be provided.

Each module is configured to operate in ATM cell delineation. The interface is presented as an optical fiber ST female connector that can accept either an OC-3 (155 Mbps) or STM-1 (155 Mbps) facility interface.

The module has the following characteristics:

1. 1 port operating at 155 Mbps line rate software configurable between either the OC-3 or STM-1 format.

2. Each port may connect to an ATM switch via UNI using a supported interface.

3. Physical interface is single or multimode optical fiber.

4. One or more modules may be inserted into any of IAD's slots depending upon availability.

5. This module is easily swappable without the need for specialist knowledge or equipment. The IAD will probably require rebooting and reconfiguring upon change of module type.

FIG. 15 shows the faceplate of the module.

Network Module

A 2×port SDSL network module for the SDSL network can be provided.

The module may be configured to operate in ATM cell delineation or Frame Relay delineation mode. The module may be configured to communicate with another IAD, DSLAM or other Central Office (CO) equipment. The module can be configured as either a CO or CPE (Customer Premises Equipment) device.

The module has the following characteristics:

1. 2 ports operating in variable rate SDSL (symmetric Digital Subscriber Line) using Globspan s″!2B1Q×DSL chip set. SDSL data rates of 144 kb/s, 272 kb/s, 400 kb/s, 528 kb/s, 784 kb/s, 1040 kb/s, 1168 kb/x, 1552 kb/s, 2064 kb/s, and 2320 kb/s are supported using 2B1Q line encoding data rates.

2. Each port may connect to an ATM switch via UNI, or a Frame Relay compliant device.

3. Physical interface is electrical with impedance of 50/75 Ohms. The connectors are RJ11 terminating voice grade telephone wire local loops.

4. One or more modules may be inserted into any of IAD's slots depending upon availability.

5. This module is easily swappable without the need for specialist knowledge or equipment. IAD will probably require rebooting and reconfiguring upon change of module type.

FIG. 16 shows the faceplate of the module.

Network Module

A 1×port ATM/FR for HDSL2 network can be provided.

The module may be configured to operate in ATM cell delineation or Frame Relay delineation mode. The module may be configured to communicate with another IAD, DSLAM (Digital Subscriber Line Access Multiplexer), or other Central Office (CO) equipment. The module can be configured as either a CO or CPE device.

The module has the following characteristics:

1. 1 port operating up to 1.5 Mbps using 2B1Q line encoding data rates.

2. The port may connect to an ATM switch via UNI, or a Frame Relay compliant device.

3. Physical interface is electrical with impedance of 50/75 Ohms. The connector is RJ11 terminating voice grade telephone wire local loops.

4. One or more modules may be inserted into any of IAD's slots depending upon availability.

5. This module is easily swappable without the need for specialist knowledge or equipment. IAD will probably require rebooting and reconfiguring upon change of module type.

FIG. 17 shows the faceplate of the module.

Port Module

A 1×port user or network module for synchronous serial lines can be made available.

The module is configured to operate in Frame Relay mode, clear channel or channelized mode, or ATM mode via clear channel. The module can attach to an existing Frame Relay router or other Frame Relay compliant device. The interface can be configured for either V.35 or X.21 via an adapter cable..

The module has the following characteristics:

1. 1× DB25 female DCE/DTE synchronous port supporting, RS-530, or RS-449. Data rate can be set from 64K to 8.192 Mbps, full duplex operation.

2. One or more modules may be inserted into any of IAD's slots depending upon availability.

3. The module is easily swappable without the need for specialist knowledge or equipment. The IAD will probably require rebooting and reconfiguring upon change of module type.

FIG. 18 shows the faceplate of the product guide.

User Module

A 4×port 10/100BaseT user module can be made available.

The module is configured to attach to an existing Ethernet LAN via a hub or switch. Each RJ45 port is rate auto-sensing and provides either switching of Ethernet packets between IAD's LAN interfaces or routing/bridging via AAL5 encapsulation over the ATM WAN.

The module has the following characteristics:

1. 4 ports of 10/100BaseT for local Ethernet or Telnet management access.

2. Spanning Tree protocol is supported.

3. Each port is on its own segment.

4. One or more modules may be inserted into any of IAD's slots depending upon availability.

5. The module is easily swappable without the need for specialist knowledge or equipment. IAD will probably require rebooting and reconfiguring upon change of module type.

FIG. 19 shows the faceplate of the module.

User Module A 1×port T1/E1 user module for voice T1/E1/PRI can be made available.

The module may be configured to operate in either T1 or E1 mode and connects to the customer's local PBX system. The module provides a T1/E1 trunk type interface that can support either 24 (T1) or 30 (E1) channels of voice throughput. PBX supported interface signaling includes either Robbed Bit (T1), CAS (E1), or ISDN PRI using Common Channel Signaling (CCS) to provide 23 (T1) and 30 (E1) bearer channels respectively for voice trunking. The module also contains the necessary Digital Signal Processors (DSPs) and logic to provide voice compression, silence suppression, echo cancellation, AAL1AAL2 processing, and packet to cell conversions.

The module has the following characteristics:

1. 1 port operating at either 1.544 Mbps (T1) or 2.048 Mbps (E1). The module can be ordered with support for 8, 16, 24, or 32 voice channels. These channels may be assigned to any time slot in the T1 or E1.

2. Signaling supported includes RBS, CAS (E1) and ISDN PRI (CCS).

3. Supported CCS signaling for ISDN PRI includes PRI Net5 User, PRI Net5 Network, and PRI QSIG.

4. AAL1 voice processing in accordance with af-vtoa-0078.000.

5. AAL2 voice processing in accordance with ITU-T 1.363.2.

6. Voice processing includes G.711 (64K PCM), G.726 ADPCM, G.727 EADPCM, G.729 CS-ACELP, G.729AB CS-ACELP, and G.723.1A.

7. Support for Fax Relay and voice-band signaling.

8. Physical interface is an RJ45 electrical with impedance of 100/120 Ohms.

9. One or more modules may be inserted into any of IAD's slots depending upon availability.

10. The module is easily swappable without the need for specialist knowledge or equipment. The IAD will probably require rebooting and reconfiguring upon change of module type.

FIG. 20 shows the faceplate of the module.

User Module

A 1×port T1/E1+1×port ISDN BRI user module for voice can be made available.

The PBX T1/E1 facility interface operates identically as outlined for the previous user module. Additionally, this module incorporates an ISDN BRIport that provides for attachment to a videoconferencing codec (although it may be used with any ISDN BRI compliant device).

The module has the following characteristics:

1. 1 port operating at either 1.544 Mbps (T1) or 2.048 Mbps (E1). The module can be ordered with support for 8, 16, 24, or 32 voice channels.

2. Identical characteristics to that of the PBX E1/T1 module.

3. 1 ISDN BRI port providing 2×64K bearer channels and 1×16K D channel. Both S/T and U interfaces are supported.

4. One or more modules may be inserted into any of IAD's slots depending upon availability.

5. The module is easily swappable without the need for specialist knowledge or equipment. The IAD will probably require rebooting and reconfiguring upon change of module type.

FIG. 21 shows the faceplate of the module.

User Module

A 2×port ISDN BRI or 3×port ISDN BRI user module for integrated service digital network can be made available.

This module is equipped with either a dual port or triple port ISDN BRI facility that supports S/T and U interfaces. Each port can be configured to support voice, fax, or voice-band data signals. Full voice processing is supported for compressed or uncompressed transmission across the ATM WAN.

Each version of the module has the following characteristics:

1. 2 or 3 ports providing ISDN BRI service. Each port supports 2×64K bearer channels and 1×16K D channel. Both S/T and U interfaces are supported.

2. One or more modules may be inserted into any of IAD's slots depending upon availability.

3. Both modules are easily swappable without the need for specialist knowledge or equipment. The IAD will require rebooting and reconfiguring upon change of module type.

FIG. 22 shows the faceplate of the module.

In one embodiment, the IAD comprises a main processing board that contains core memory, application code, and optional interface modules. A key element of this design is the ATM switch processor.

The ATM switch processor consists of a cell switching fabric with segmentation and re-assembly processes and a cell forwarding architecture that includes a cell scheduler function. It contains the necessary logic and dynamic tables to translate between ATM VCs and Frame Relay DLCIs. Additionally, through its powerful scheduling ability, it supports current ATM and Frame Relay Quality of Service (QoS) attributes. The processor uses an on-board CPU to build and maintain its tables and routing information.

The ATM switch processor's unique benefit is that once its tables have been defined, it converts, routes, and switches frames and cells effortlessly, in hardware, and releases the main CPU to perform other processor intensive tasks such as voice processing. Unlike other comparable CPE devices, this blend of technology enables the IAD to deliver the processing power and switching performance that would normally be found in larger and more expensive access units.

The IAD's other key components are the following subsystems:

1. ATM Processing,

2. Voice Processing,

3. Network Management.

The ATM Processing subsystem provides the broadband services to IAD's applications.

Overview

ATM processing, frame to cell conversion and transmission of cells to the ATM network modules is performed by the ATM switch processor.

The following ATM Adaptation Layers (AAL) and associated service classes are supported:

TABLE 2
Supported AAL Protocols

| Layer | Service Class | Mnemonic |
|---|---|---|
| AAL1 | Constant Bit Rate | CBR |
| AAL2 | Variable Bit Rate | VBR-rt |
| | | VBR-nt |
| AAL5 | Unspecified Bit Rate | UBR |
| | | UBR+ |

AAL1 Operation. This layer is used to support all switched or permanent uncompressed voice calls. Uncompressed voice traffic is either carried as a structured or basic Nx64K CES cell stream as defined in the af-vtoa-0078.000 interoperability specification, Circuit Emulation Services (v2).

AAL2 Operation. This layer is used to support all switched compressed voice calls over the ATM network. All AAL2 voice traffic between a pair of IADs is multiplexed across a single ATM VC.

AAL5 Operation. This layer is used to support all Frame Relay data frames and Internet data packets over the ATM network.

Quality of Service. The IAD performs traffic shaping of its outgoing ATM cell flow in accordance with the relevant standard for Connection Traffic Descriptor that was negotiated with the ATM network. The relevant parameters used to specify unambiguously the conforming cells of the ATM connection are Peak Cell Rate (PCR), Sustainable Cell Rate (SCR), and Maximum Burst Size (MBS). IAD contains two leaky buckets to support its QoS scheduling.

Inverse Multiplexing over ATM Interface. The IAD can be configured to accept 2 Mbps circuits via a 4-port E1/T1 IMA interface, which can be configured into two IMA logical groups. Typically, ATM PVCs would utilize all available circuits in the IMA group to provide greater throughput. An outline flow of ATM cells through an IMA configuration is illustrated in FIG. 23. Here, an ATM data stream is split across three individual physical links on a cell-by-cell basis in a “round-robin” effect.

Frame Relay to ATM Operation. The IAD supports both Frame Relay to ATM “Network” and “Service” interworking as defined by the Frame Relay Forum's Frame Relay/ATM Network and Service Interworking Implementation Agreements (FRF.5 and FRF.8 respectively).

Network Interworking. This function is responsible for forwarding frames between the Frame Relay interface and the ATM Data Subsystem. The IAD processes frames received from the Frame Relay interface as follows:

1. De-multiplexed according to their DLCI.

2. Stripped of their HDLC encapsulation headers.

3. BECN (Backward Explicit Congestion Notification), FECN (Forward Explicit Congestion Notification), and DE (Disregard Eligibility) congestion and flow control indicators are mapped according to ATM EFCI (Explicit Forward Congestion) and CLP (Cell Loss Priority) settings.

4. Re-encapsulated in ATM AAL5 CPCS PDUs.

5. Segmented and multiplexed over the UTOPIA (Universal Test and Operations Interface for ATM) cell interface according to the ATM VCC (Virtual Channel Connection).

In the reverse direction, the ATM cell traffic is processed as follows:

1. ATM AAL5 CPCS PDUs (Protocol Data Unit) reassembled from the UTOPIA cell interface.

2. De-multiplexed according to the ATM VCC.

3. Stripped of their AAL5 encapsulation overhead bytes.

4. ATM EFCI, DE congestion, and flow control indicators are mapped according to FR BECN, FECN, and DE settings.

5. Multiplexed over the appropriate Frame Relay interface according to DLCI.

FIG. 24 illustrates Network interworking mapping performed between frames and cells.

The Service Interworking (FRF.8). This function is essentially the same as the previous network function, except that protocol conversion algorithms are applied to convert Frame Relay bridged or routed PDU to ATM bridged or routed PDUs. Frames received from the Frame Relay interface are processed as follows:

1. De-multiplexed according to their DLCI.

2. Stripped of their HDLC encapsulation headers.

3. Network protocol encapsulation headers mapped from those specified in RFC 1490 (for Frame Relay) to those specified in RFC 1483 (for ATM).

4. Re-encapsulated in ATM AAL5 CPCS PDUs.

5. Segmented and multiplexed over the UTOPIA cell interface according to the ATM VCC.

In the reverse direction, the IAD processes the ATM cell traffic as follows:

1. ATM AAL5 CPCS PDUs reassembled from the UTOPIA cell interface.

2. De-multiplexed according to the ATM VCC.

3. Stripped of their AAL5 encapsulation overhead bytes.

4. Network protocol encapsulation headers mapped from those specified in RFC 1483 (for ATM) to those specified in RFC 1490 (for Frame Relay).

5. Multiplexed over the appropriate Frame Relay interface according to DLCI.

FIG. 25 illustrates Service Interworking mapping performed between frames and cells.

Ethernet Operation

The IAD is assigned an IP address and subnet mask to each network port (including ATM WAN ports). Services such as Domain Host Control Protocol (DHCP) and Network Address Translation (NAT) are supported.

The IAD performs both local IP routing (RIPv1 & v2) and switching between its local and network ports. Bridging between a pair of IADs is achieved by using ATM bridging multi-protocol encapsulation techniques over AAL5 (RFC 1483) and Classical IP encapsulation (RFC1577).

Other protocols built into the IAD IP stack include the following protocols: UDP, TCP, TFTP, SNMP, ARP, and ICMP. Telnet packets received from the local ports or via the network ports are converted to command strings and passed to the IAD's command line interface (CLI) for parsing.

Domain Host Configuration Protocol

The Dynamic Host Configuration Protocol's (DHCP) purpose is to enable individual computers on an IP network to extract their configurations from a server (the ‘DHCP server’) or servers, and in particular, servers that have no exact information about the individual computers until they request the information. The overall purpose of this is to reduce the work necessary to administer a large IP network. IAD contains a DHCP server function

Network Address Translation (NAT) is used to translate one IP address to another. NAT can be used to allow multiple PCs to share a single Internet connection. It can also be used as a security tool by shielding the IP addresses of devices within the attached intranet. NAT can also be used for general IP address management by protecting the attached intranet from excessive address changes due to other network addressing constraints.

Voice Processing. This subsystem provides the voice and video-oriented narrowband services to the IAD's applications.

This section describes the functional aspects of IAD's voice processing capabilities. the IAD's voice traffic across the ATM WAN is managed using a mixture of both AAL1 CBR connections and AAL2 VBR-rt connections.

AAL1 is used to carry uncompressed voice channels and associated Robbed Bit or CAS signaling transparently, end-to-end. AAL2 is used in conjunction with a signaling and compression engine such as Mariner Networks' proprietary signaling and compression engine, to switch and carry packetized, compressed voice traffic end-to-end. The AAL type is software configurable on a trunk channel basis, and compression algorithm/ratio basis.

The IAD utilizes structured Circuit Emulation Services (CES), nailed up circuits supporting Nx64K (uncompressed) between IADs, or between the IAD and other vendors' equipment supporting standards-based CES. While uncompressed CES-based connections are less efficient than compressed, AAL2 based connections, they offer the greatest benefit in terms of end-to-end voice quality and interoperability.

FIG. 26 illustrates some of the network interconnection scenarios that can be implemented using structured circuit emulation with a IAD network.

In FIG. 26, each of the ATM PVCs shown (A, B, C) carries a fixed, constant bit rate stream of ATM cells. The cell payloads, formatted according to the rules specified in af-vtoa-0078.000, contain voice samples and robbed bit signaling information for the trunk channels that the associated PVCs are configured to transport between the attached voice interfaces and the ATM network.

A CES connection provides a “nailed-up” transport for TDM voice data and voice signaling, allowing geographically dispersed telephony endpoints to communicate transparently over the ATM network.

Circuits can be configured for either “Basic Mode”, meaning that trunk channels are transported without associated signaling, or CAS mode, meaning that CAS/robbed bit signaling information is included in the cell payloads. The latter is useful for connecting non-PBX type equipment (e.g., analog handsets) at one end to PBX/trunk terminating equipment at the other end (loop extension).

Compressed Voice Services

By using AAL2 VBR-rt ATM circuits in conjunction with IAD's compression and signaling software, IAD can more efficiently transport voice and fax traffic across the ATM WAN.

AAL2 provides for the bandwidth-efficient transmission of low-rate, short, and variable packets in delay sensitive applications. ATM's VBR-rt services enable statistical multiplexing for the higher layer requirements demanded by voice applications, such as compression, silence detection/suppression, and idle channel removal. Additionally, in contrast to AAL1 (which has a fixed payload), AAL2 offers a variable payload within cells and across cells.

Compression and signaling software, such as Mariner Networks' compression and signaling software, terminates the local signaling channels and provides inter-IAD proxy signaling over AAL5. This signaling provides for compressed calls that includes Robbed Bit/CAS modes, and out-of-band Common Channel Signaling (CCS) for a number of message oriented signaling protocols.

The IAD support compressed calls with in-band signaling (Robbed Bit/CAS) for non-ISDN T1/E1 interfaces and the following CCS variants when IAD is configured for ISDN PRI mode:

1. PRI Net5 User Mode

2. PRI Net5 Network Mode

3 PRI QSIG.

FIG. 27 illustrates some of the network interconnection scenarios that can be implemented using a network of IADs and voice compression and multiplexing technologies.

FIG. 27 has the following key attributes:

1. Any combination of AAL1 uncompressed and AAL2 compressed calls can be configured and carried by the IAD.

2. In addition to an AAL2 VCC between a pair of IADs, an AAL5 signaling VCC is required to carry the IAD's signaling protocol for switched, compressed voice/fax calls, such as Mariner Networks' proprietary signaling protocol for switched, compressed voice/fax calls.

3. Inter-IAD AAL2 compressed VCCs can be used to connect dissimilar PBX technologies (e.g., ISDN PRI using CCS to standard T1 using robbed bit signaling).

4. The IAD can also support analog interfaces that directly interface to fax machines, emulating the functions of a PBX to the attached devices.

Protocols and Standards Compliance

The IAD implements a combination of both standards-based and non-standards-based software protocols. The following sections provide an overview of these protocols.

AAL1 Protocol

The IAD implements Nx64K structured mode CES over AAL1, as defined in af-vtoa-0078.000. The IAD is loaded with conventional software configurable, on a per-VCC basis, to run either Basic or CAS-mode CES for configured trunk channels. Trunk channels carried via CES are transported in uncompressed, 64K PCM format. The IAD does not implement unstructured mode CES (as defined in af-vtoa-0078.000), nor does it implement SRTS clock recovery as defined for AAL1 transport by the ATM Forum and ITU.

AAL2 Protocol

The IAD implements a software based AAL2 implementation that is proprietary. This implementation utilizes the “general framework and Common Part Sublayer (CPS)” of the AAL type 2 defined in ITU-T Recommendation 1.363.2. The associated cell payloads comprise compressed voice/fax data output by the IAD compression engine.

It is preferred to implement standards-based software solutions wherever possible to maximize interoperability opportunities. Once the standards for AAL2 signaling have been agreed and accepted, such solutions will preferably be implemented into IAD's AAL2 voice processing software.

AAL5 Protocol

The IAD implements the ITU-T 1.363.5-compliant AAL5 UBR transport mechanisms widely deployed today. This service is used to convey IAD voice signaling messages in conjunction with AAL2-based voice traffic.

Voice Compression

Voice compression is performed by IAD's compression engine that consists of software logic and a number of Digital Signaling Processors (DSPs). The IAD can be configured to operate with a number, such as 4 DSPs. Each DSP can support the processing of numerous, such as 8, voice channels concurrently. The IAD can be configured to support any set of the following voice encoding techniques:

1. G.711 PCM, 64 Kbps

2. G.726 ADPCM, rates 16, 24, 32, and 40 Kbps

3. G.727 EADPCM, rates 16, 24, 32, and 40 Kbps

4. G.729A CS-ACELP and G.729B CS-ACELP, 8 kbps rate

5. G.723.1A, rates 5.3 and 6.3 Kbps.

Proprietary Protocols

As the ATM Forum and/or the ITU do not yet standardize signaling for AAL2, IAD's utilize the proprietary Helium™ signaling protocol to establish and tear down individual compressed voice calls. These calls are signaled using Robbed Bit/CAS/CCS modes on the facility side, and converted to/from the IAD's proprietary “Q.931-like” signaling protocol for managing inter-IAD call states. Conventional signaling protocol may be used.

PBX Interface Mode

The IAD can operate in one of three modes: North American T1, Standard E1, and E1-based ETSI ISDN PRI.

In T1 mode, narrowband signaling is via the AB bit transitions in robbed bit frames of the T1 Super Frame (SF) or Extended Super Frame (ESF) multiframe. In E1 (non PRI) mode, narrowband signaling is via CAS AB bit transitions in slot 16 of all frames in the E1 (FAS/CAS or FAS/CAS-CRC4) multiframe. In E1 PRI mode, narrowband signaling is configurable as QSIG, PRI NET5 User Side, or PRI NET5 Switch Side, via CCS in timeslot 16 of all frames in the E1 (FAS/CAS or FAS/CAS-CRC4) multiframe.

Trunk Channel Signaling

IAD supports the following narrowband signaling protocols for trunk channel signaling. For each channel, one of the following may be selected as the signaling protocol:

1. Foreign Exchange Station Loop Start or Ground Start

2. Foreign Exchange Office Loop Start or Ground Start

3. E&M Immediate Start

4. E&M Delay Start

5. E&M Wink Start.

This operation is unavailable when the IAD is operating in PRI (Primary Rate Interface) mode.

Voice Coding Profiles

PCM (Pulse Code Modulation) voice samples from the PBX (Private Branch Exchange) interface are switched through the IAD's on-board Digital Signaling Processors (DSPs), on a per-call basis, in order to perform the required compression, silence suppression, voice activity detection, and echo cancellation processes. All DSPs (up to a maximum of 4) are loaded with the same image at power up, which supports the following protocols (on a per channel basis, 8 channels per DSP):

1. G.711

2. G.729A and B

3. G.726

4. G.727

5. Standard Fax relay.

Configuration of the DSP feature set is achieved through the creation of “Voice Coding Profiles”. A coding profile is a set of configuration parameters that is assigned to a compressed call. The information in the coding profile informs the DSP how to process and route the compressed call through the system.

Coding profiles with common characteristics must be configured on both IAD peers in order for a call to be successfully placed between them. At the originating end, a coding profile is assigned to a destination telephone number. When a call request for a particular destination is received from the telephony interface at the originating end, the parameters from the associated coding profile are negotiated with the remote peer via the IAD's proprietary signaling message elements. At the remote end, a coding profile will have been associated with the telephony destination through prior configuration.

Common elements from the originating side's coding profile and the destination side's coding profile are then negotiated and converged upon (via signaling) to create the set of parameters used to configure the associated DSP voice channels at both ends. Once this process is completed, the voice call is considered active.

Dial Plan Configuration

In addition to physical resource configuration (PBX mode, FXO, FXS, etc.), a dial plan that specifies how to route calls between IAD peers is required. The IAD maintains its own dial plan that contains the following information:

1. Dialed digit timeouts and termination sequences,

2. Narrowband hunt group definitions,

3. Broadband hunt group definitions, and

4. Forwarding criteria.

SNMP (Sample Network Management Protocol)

Standard MIB (Management Information Base) support for the IAD includes:

1. RFC 1406 Standard T1/E1 MIB, and

2. Supplemental MIB supporting ANSI T1.231.

Additionally, IAD is configured with its Enterprise MIB structure to facilitate the reporting of non-standard object elements such as ISDN PRI information.

Network Management Processing

This subsystem provides the facility to control and configure the IAD's different subsystems.

Overview

The Network Management Subsystem comprises four main components that enable a network operator to configure, control, report, and perform diagnostics upon the IAD. These elements are:

1. Configuration Management,

2. Connection Management,

3. Fault Management, and

4. Performance Management.

Configuration Management

This component provides functions to configure all aspects of the IAD's physical interfaces, signaling protocol parameters, and call control parameters. From a management perspective, this involves the following entities:

1. General node configuration,

2. E1/T1 port and subchannels,

3. BRI-ISDN, 10 BaseT, V.35, and RS-232C ports,

4. ATM and IMA ports,

5. Narrowband signaling,

6. Inter-IAD communications,

7. Voice coding profiles,

8. Routing, narrowband, and broadband addressing tables,

9. OAM segmentation end points table,

10. Frame Relay and IP interworking tables, and

11. CES configuration.

Connection Management

Connection Management is a set of functions that is used to track the various call or connection oriented entities and configuration of PVCs, including applications they support. From a node management perspective, this involves describing the details of:

1. Active call connections between narrowband and broadband resources,

2. Active broadband connections for the total system,

3. PVCs created for the broadband entities,

4. PVCs created for the narrowband entities, and

5. Call history information.

Fault Management

Fault Management is a set of functions that enable the detection, isolation, and correction of abnormal operation of the telecommunications parts of the network and its environment. From a node perspective, this tracks the following entities:

1. Physical facility and port failures,

2. Call control failures,

3. ATM OAM cell loopback tests, and

4. Sundry fault management and vendor-specific diagnostics.

Performance Management

Performance Management provides functions to evaluate and report upon the behavior of telecommunication/data equipment and the effectiveness of the overall network or network element. From a node management perspective, this involves general performance, traffic, and data collection routines against the following entities:

1. Physical layer performance monitoring of all ports,

2. Cell level performance monitoring, and

3. ATM layer protocol and performance monitoring.

Standards Compliance

The standards and compliance specifications relevant to IAD are.

ANSI Documents

1. T1.CBR-199X Draft—Broadband ISDN—ATM Adaptation Layer for Constant Bit Rate Services, Functionality and Specification, November 1992.

2. T1.102-1993, Digital Hierarchy, Electrical Interfaces, December 1993.

3. T1.107-1995, Digital Hierarchy, Formats Specifications, 1995.

4. T1.231-1993, Digital Hierarchy, Layer 1 In-Service Digital Transmission Performance Monitoring, September 1993.

5. T1.403-1995, Carrier-to-Customer Installation, DS1 Metallic Interface, March 1995.

6. T1.408-1990, Integrated Services Digital Network (ISDN) Primary Rate—Customer Installation Metallic Interfaces Layer 1 Specification, September 1990.

7. T1.606, T1.606a, T1.606b Frame Relay Bearer Service, Architectural Framework and Service Description, ANSI, 1990.

8. T1.646-1995, Broadband ISDN, Physical Layer Specifications for User-Network Interfaces Including DS1/ATM, 1995.

9. EIA/T1A-547, Network Channel Terminal Equipment for DS1 Service, March 1989.

ATM/Frame Relay Forum Documents

11 AF-VTOA-0078.000, Circuit Emulation Service Interoperability Specification, Version 2.0, January 1997.

12. The ATM Forum, af-vtoa-0089.000, “Voice and Telephony Over ATM—ATM Trunking using AAL1 for Narrowband Services Version 1.0”, July 1997.

13. The ATM Forum, af-phy-0086.000, “Inverse Multiplexing for ATM (IMA) Specification, Version 1.0, July 1997.

14. The ATM Forum, af-vtoa-0113.000, “ATM Trunking using AAL2 for Narrowband Services”, Version 1.0, February 1999.

15. UTOPIA, An ATM-PHY Interface Specification, Level 2, Version 0.95, June 1995. ATM User-Network-Interface Specification, Version 3.1, September 1994, ATM Forum.

16. UTOPIA, An ATM-PHY Interface Specification, Level 2, Version 0.95, June 1995, ATM Forum.

17. Network Working Group, RFC 1483, “Multiprotocol Encapsulation over ATM Adaptation Layer 5”.

18. FRF.1.1, User-to-Network Implementation Agreement.

19. FRF.3.1, Frame Relay Forum Multiprotocol Over Frame Relay.

20. Frame Relay/ATM PVC Network Interworking Implementation Agreement, Document Number FRF.5, Dec. 20, 1994.

21. Frame Relay Forum. Frame Relay/ATM PVC Service Interworking Implementation Agreement, Document Number FRF.8, Apr. 15, 1995.

IETF

22. RFC 1483 Multiprotocol Encapsulation Over AAL5, July 1993.

23. RFC 1490 Multiprotocol Interconnect Over Frame Relay, July 1993.

24. RFC1577 Classical IP and ARP over ATM, January 1994.

ITU Documents

25. ITU-T Recommendation G.168, Digital Network Echo Cancellers, April 1997.

26. Draft new ITU-T Recommendation 1.363.2, B-ISDN ATM Adaptation Layer Type 2 Specification, February 1997.

27. ITU-T Recommendation 1.362 B-ISDN ATM Adaptation Layer(AAL) Functional Description.

28. ITU-T Recommendation I.363 B-ISDN ATM Adaptation Layer(AAL) Description.

29. Recommendation G.703, Physical/Electrical Characteristics of Hierarchical Digital Interfaces, 1991.

30. Recommendation G.704, Synchronous Frame Structures Used at Primary and Secondary Hierarchical Levels, 1991.

31. Recommendation G.706, Frame Alignment and Cyclic Redundancy Check (CRC) Procedures Relating to Basic Frame Structures Defined in

32. Recommendation G.704, 1991.

33. Recommendation G.804, ATM Cell Mapping into Plesiochronous Digital Hierarchy (PDH), January 1993.

34. Recommendation G.823, The Control of Jitter and Wander Within Digital Networks Which are Based on the 2048 kbit/s Hierarchy, 1993. Recommendation G.826, Error Performance Parameters and Objectives for International, Constant Bit Rate Digital Paths at or above the Primary Rate, 1993.

35. Recommendation G.832, Transport of SDH Elements on PDH Networks: Frame and Multiplexing Structures, 1993.

36. Recommendation I.233.1, Framework for providing additional packet mode bearer services, ITU-T, 1988.

37. Recommendation I.370, Congestion management for the ISDN Frame Relaying bearer service, ITU-T, 1988.

38. Recommendation I.431, Integrated Services Digital Network (ISDN) User-Network Interface, Primary Rate UNI Layer 1 Specification, March 1993.

39. Recommendation I.432, Broadband Integrated Services Digital Network (B-ISDN) User-Network Interface, Physical Layer Specification, March 1993.

40. Recommendation I.610, Broadband Integrated Services Digital Network (B-ISDN) Operation and Maintenance, Principles and Functions, March 1993.

41. Recommendation Q.922 ISDN Data Link Layer Specification for Frame Mode Bearer Services, 1992.

42. ITU-T Recommendation Q.931, DSS1—ISDN User-Network interface layer 3 specifications for basic call control.

43. Recommendation Q.933, Digital Subscriber Signaling System No. (DSS 1), Signaling For Frame Mode Basic Call Control, ITU-T, 1993.

Other Related Documents

44. EN50082-1 “Electromagnetic compatibility, Generic immunity standard, Part 1: Residential, commercial and light industry”. EN 50082-1:1997 (or BS EN 50082-1:1998).

45. ENV 50204 “Radiated electromagnetic field from digital radio telephones—Immunity test”. ENV 50204:1995.

46. IEC 61000-4-2 “Electromagnetic compatibility (EMC), Part 4-2: Testing and measurement techniques, Electrostatic discharge immunity test”. IEC 61000-4-2 Consol. Ed. 1.1 (incl. am1), 1999-05.

47. IEC 61000-4-3 “Electromagnetic compatibility (EMC), Part 4-3: Testing and measurement techniques, Radiated, radio-frequency, electromagnetic field immunity test”. IEC 61000-4-3 - Consol. Ed. 1.1 (incl. am1), 1998-11.

48. IEC 61000-4-4 “Electromagnetic compatibility (EMC), Part 4: Testing and measurement techniques, Section 4: Electrical fast transient/burst immunity test. Basic EMC Publication”. IEC 61000-4-4 - Ed. 1.0, 1995-01.

49. IEC 61000-4-5 “Electromagnetic compatibility (EMC), Part 4: Testing and measurement techniques, Section 5: Surge immunity test”. IEC 61000-4-5 - Ed. 1.0, 1995-02.

50. IEC 61000-4-6 “Electromagnetic compatibility (EMC), Part 4: Testing and measurement techniques, Section 6: Immunity to conducted disturbances, induced by radio-frequency fields”. IEC 61000-4-6 - Ed. 1.0, 1996-04.

51. IEC 61000-4-8 “Electromagnetic compatibility (EMC), Part 4: Testing and measurement techniques, Section 8: Power frequency magnetic field immunity test. Basic EMC Publication”. IEC 61000-4-8 - Ed. 1.0, 1993-06.

52. IEC 61000-4-11 “Electromagnetic compatibility (EMC), Part 4: Testing and measuring techniques, Section 11: Voltage dips, short interruptions and voltage variations immunity tests”. IEC 61000-4-11 - Ed. 1.0, 1994-06.

53. EN50081-1 “Electromagnetic compatibility, Generic emission standard, Part 1: Residential, commercial and light industry”. EN 50081-1:1992. FCC Part 15 “RADIO FREQUENCY DEVICES”. Downloaded October 1998. Federal Communications Commission, USA.

54. EN55022 “Information technology equipment, Radio disturbance characteristics, Limits and methods of measurement”, CISPR 22—Ed. 3.0—Bilingual, 1997-11, or EN 55022:1998.

55. EN 55014-1 “Electromagnetic compatibility, Requirements for household appliances, electric tools and similar apparatus, Part 1: Emission, Product family standard”. EN 55014-1:1993/A2:1999.

56. EN 61000-3-2 Electromagnetic compatibility (EMC), Part 3-2: Limits—Limits for harmonic current emissions (equipment input current up to and including 16A per phase)”. EN 61000-3-2:1995/A2:1998.

57. EN 61000-3-3 “Electromagnetic compatibility (EMC), Part 3: Limits—Section 3: Limitation of voltage fluctuations and flicker in low-voltage supply systems for equipment with rated current up to 16 A”. EN 61000-3-3:1995.

58.. IEC60950 “Safety of information technology equipment.” IEC 60950 (1999-04) (Ed.3).

59. EN60950 “Safety of information technology equipment.” EN 60950:1992/A4:1997.

60. UL 1950 “Standard For Safety For Information Technology Equipment”, UL 1950_{—}3 third edition 1995.

61. UL 1459 “Standard For Safety For Telephone Equipment”, UL 1459 third edition 1995.

62. EN 41003 “Particular safety requirements for equipment to be connected to telecommunication networks”, EN 41003:1998.

Books

63. Demystifying ATM/ADSL, Busby, Michael; Wordware Publishing, Inc.; 1998.

64. QoS & Traffic Management in IP & ATM Networks; McDysan, David; McGraw-Hill; 2000.

65. ATM Theory and Application; McDyson, David E. and Spohn, Darren L.; McGraw-Hill; 1998.

66. ATM for Dummies; Gadeck; Cathy and Heckart, Christine; IDG Books Worldwide, Inc.; 1997.

67. Networking for Dummies; Lowe, Doug; IDG Books Worldwide, Inc.; 1994.

The above documents and books are incorporated by reference herein.

Related websites include: www.atmforum.com; www.cis.ohio-state.edu/˜jain/refs/atm-book.htm (extensive list of ATM network related books);

www.networking.ibs.com/atm/atmover.html; //members.tripod.com/˜vbkurnar/atm.html (extensive lists of glossaries, acronyms, telecommunications associations, organizations and forums); www.marinernetworks.coml; www.dexteraccess.com.

### BRIEF DESCRIPTION OF THE DRAWINGS

FIG. 1 is a simplified, partly schematic perspective view of an Integrated Access Device For Asynchronous Transfer Mode (ATM) communications Interface Module according to the present invention.

FIG. 2 is a top-level block diagram of the device of FIG. 1, showing major components thereof.

FIG. 3 is a more detached block diagram of the device of FIG. 1.

FIG. 4 is a schematic diagram showing software modules of the device of FIG. 1.

FIG. 5 is a block diagram of a voice card module according to the present invention useable with the device of FIG. 1.

FIG. 6 is a block diagram of another embodiment of a voice card module according to the present invention and useable with the device of FIG. 1.

FIG. 7 is a perspective view of the device of FIG. 1, showing three different modules according to the present invention plugged into three different expansion ports of the device.

FIG. 8 is a schematic view showing the device of FIG. 1 interfaced with various networks and devices through its expansion port modules.

FIG. 9 is a perspective view of a T1/E1 IMA Interface Module according to the present invention and useable with the device of FIG. 1, that Module adapted to perform inverse multiplexing of up to four T1/E1 data lines.

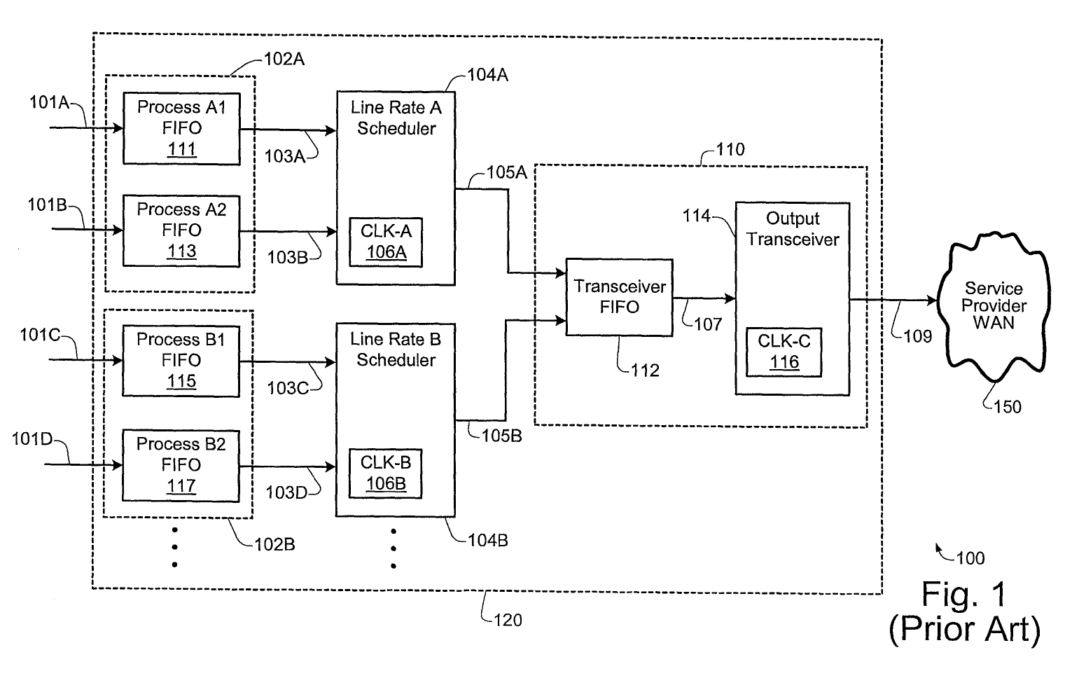

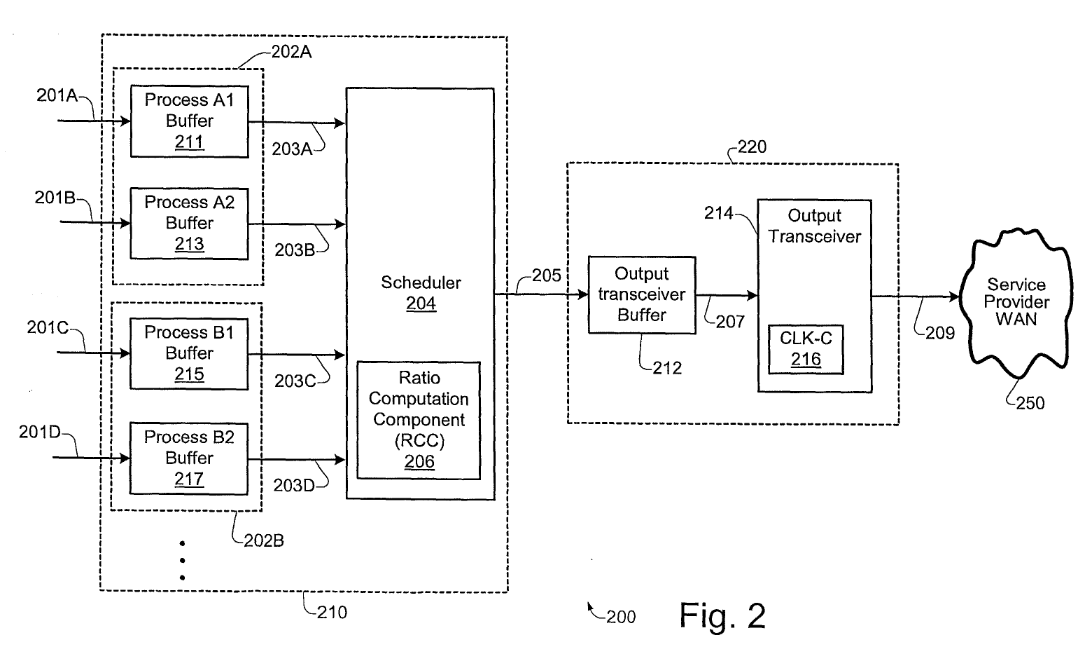

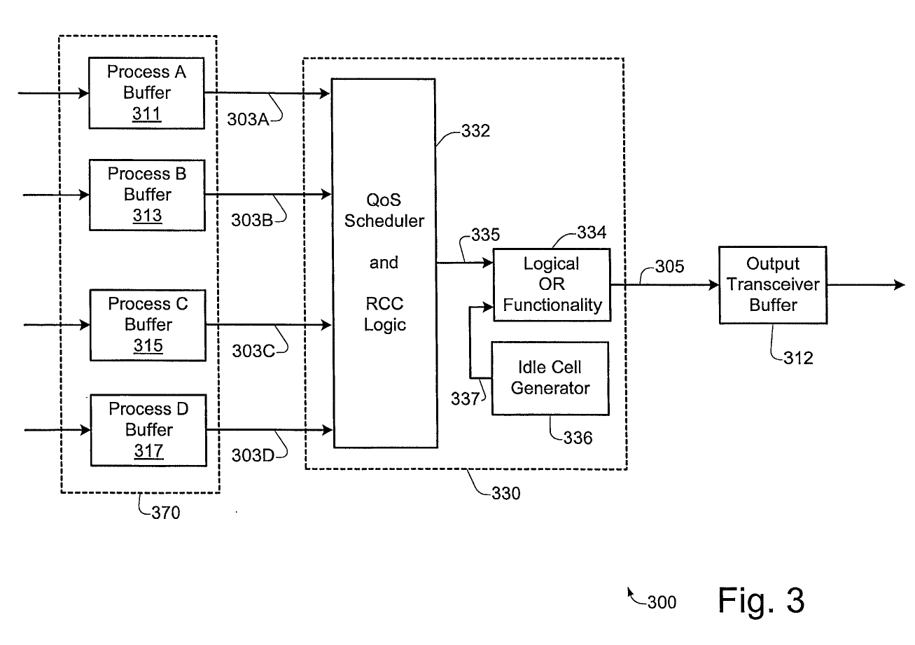

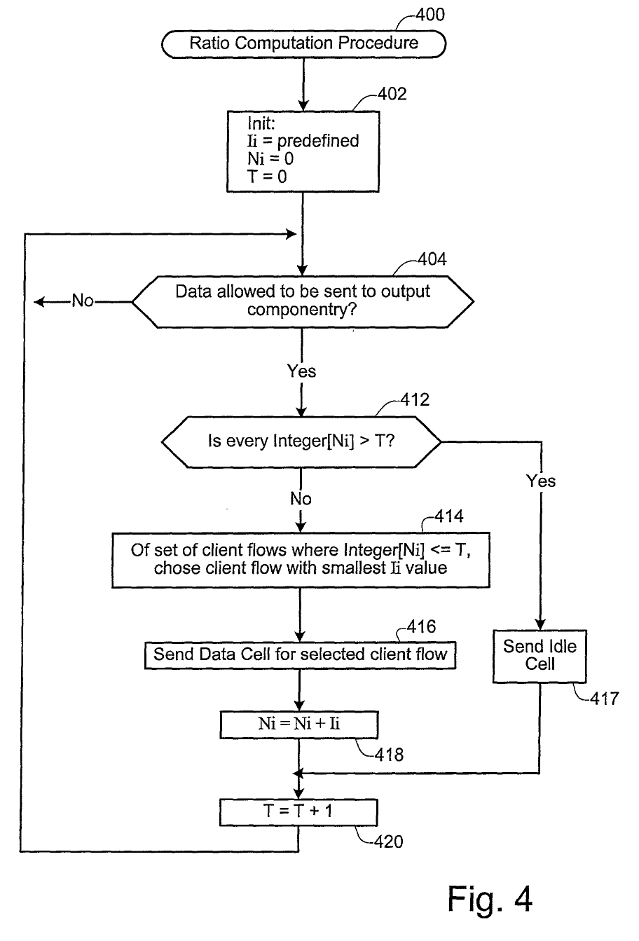

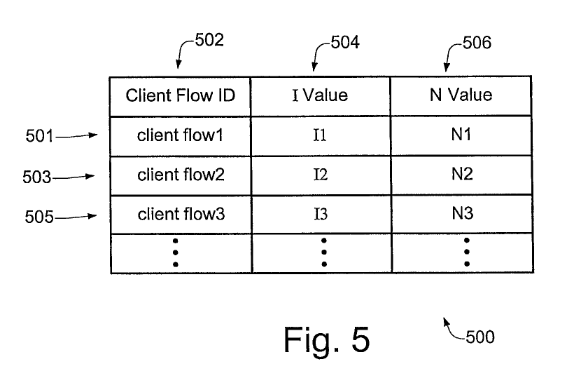

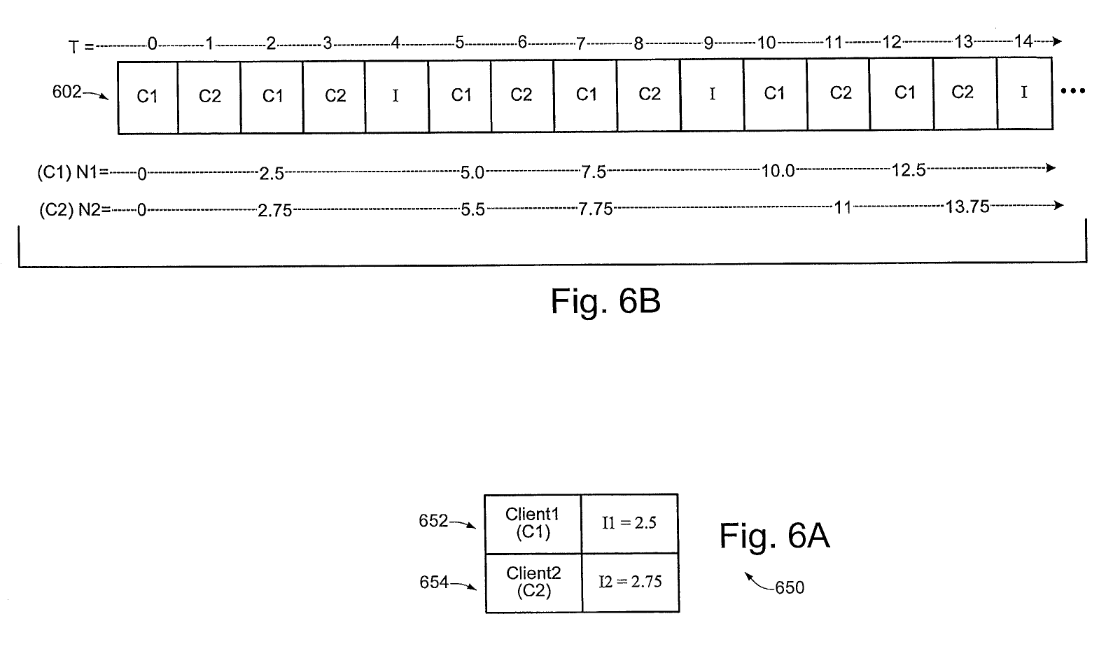

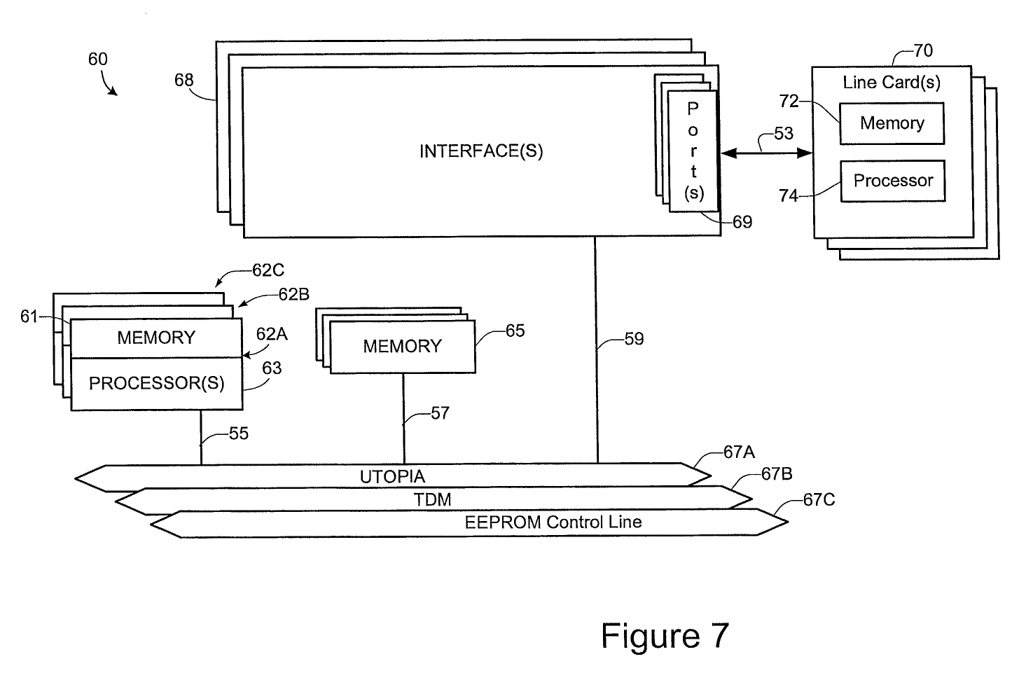

FIG. 1O is a perspective view of a Synchronous Serial Interface Module according to the present invention and useable with the device of FIG. 1, that module adapted to receive data in either an ATM cell or framed mode.

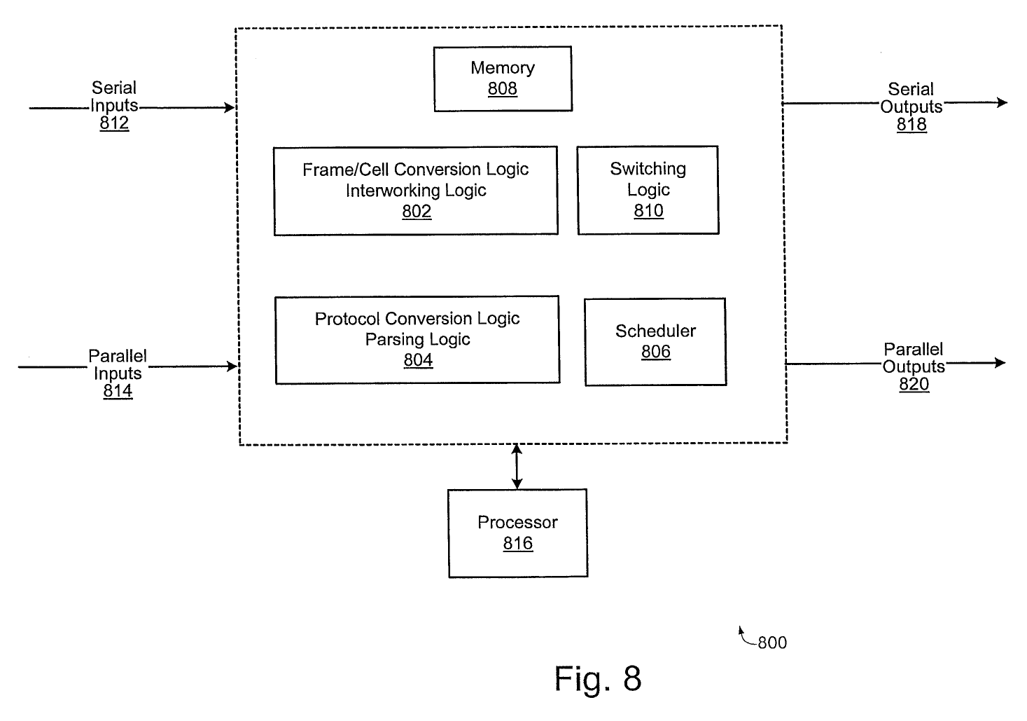

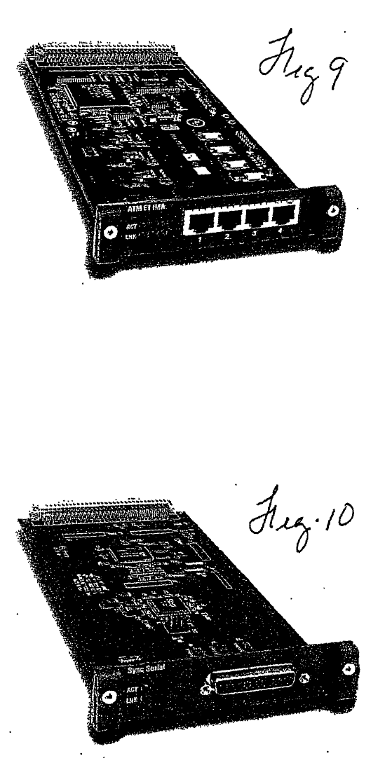

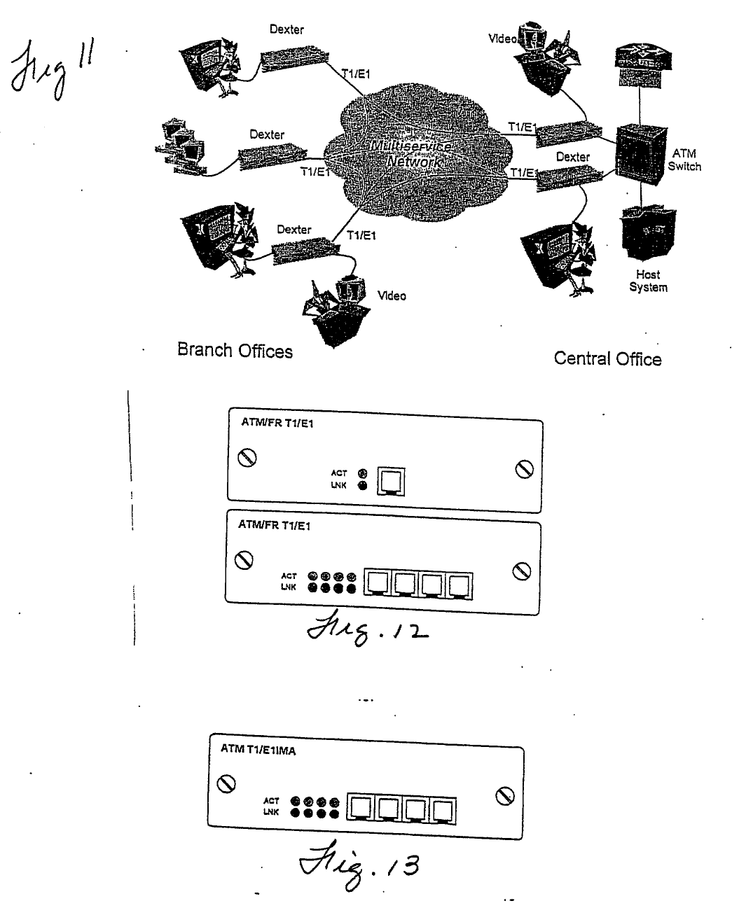

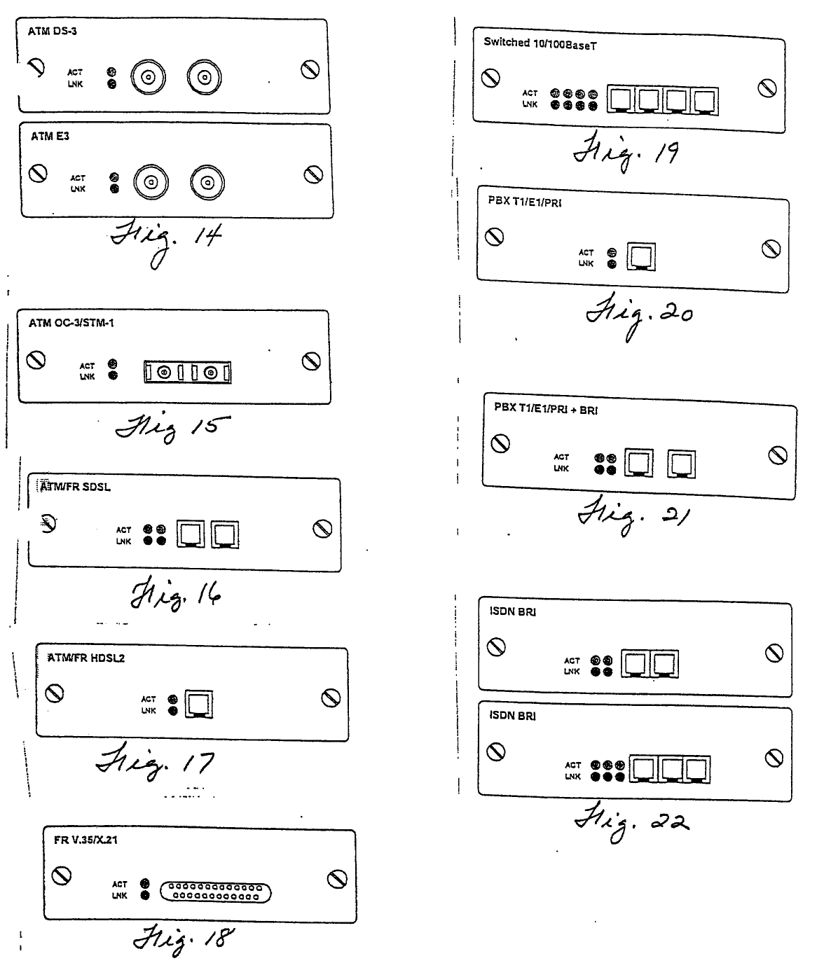

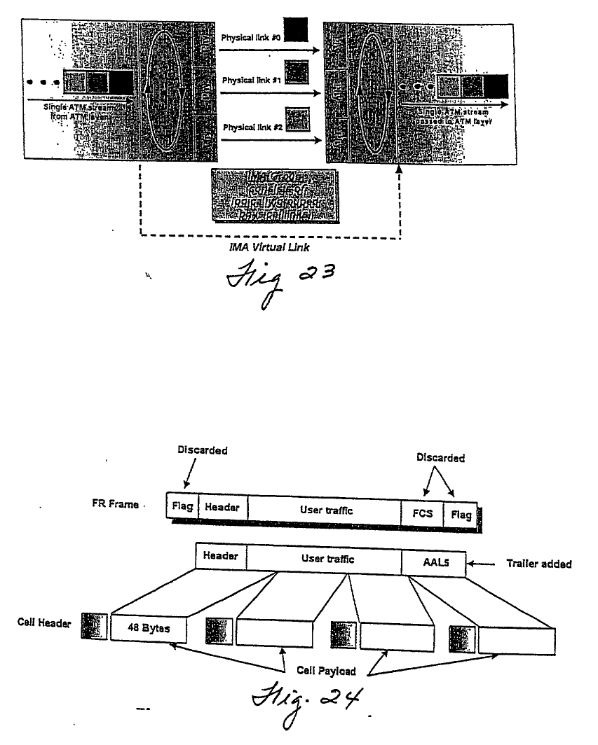

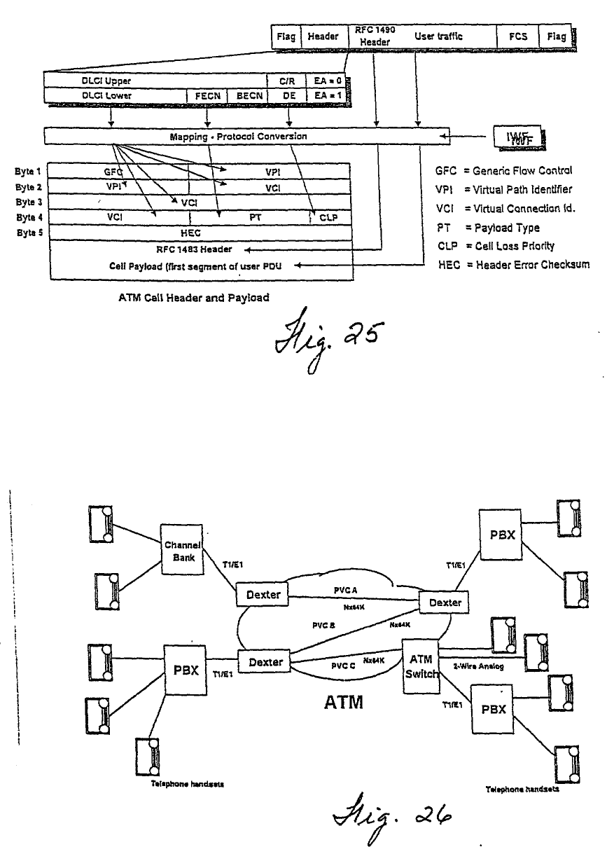

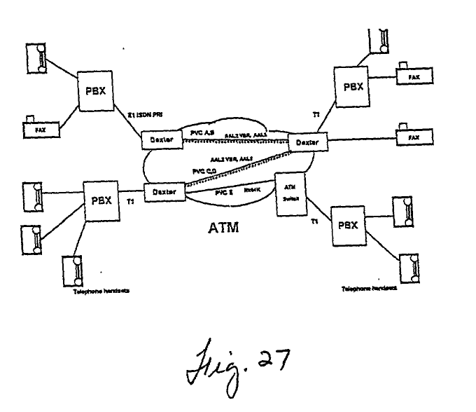

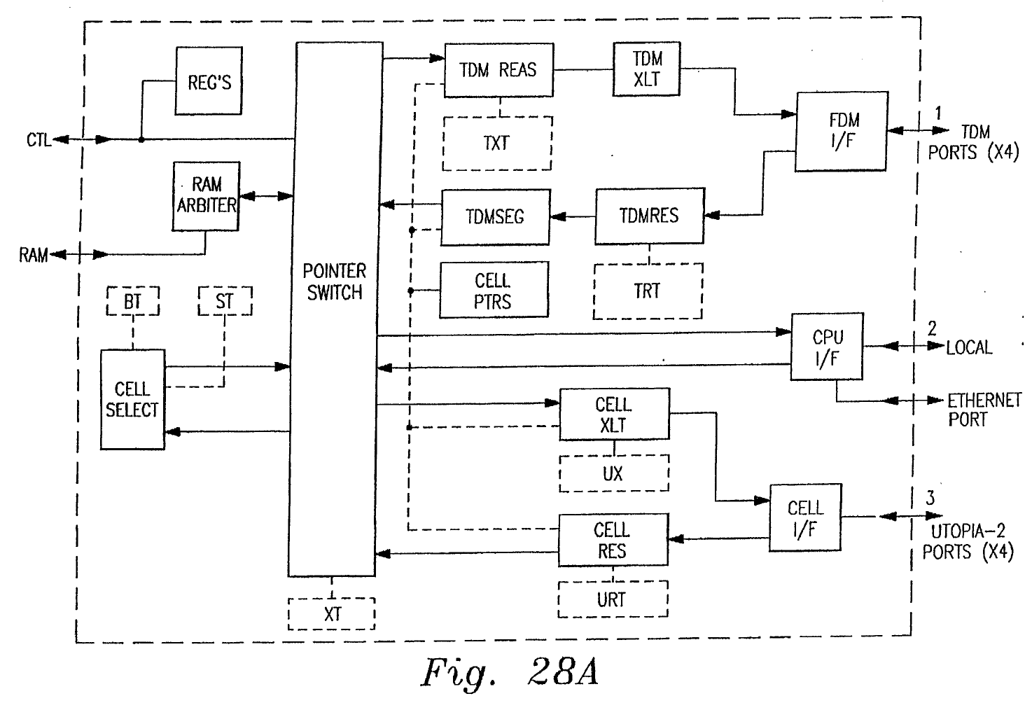

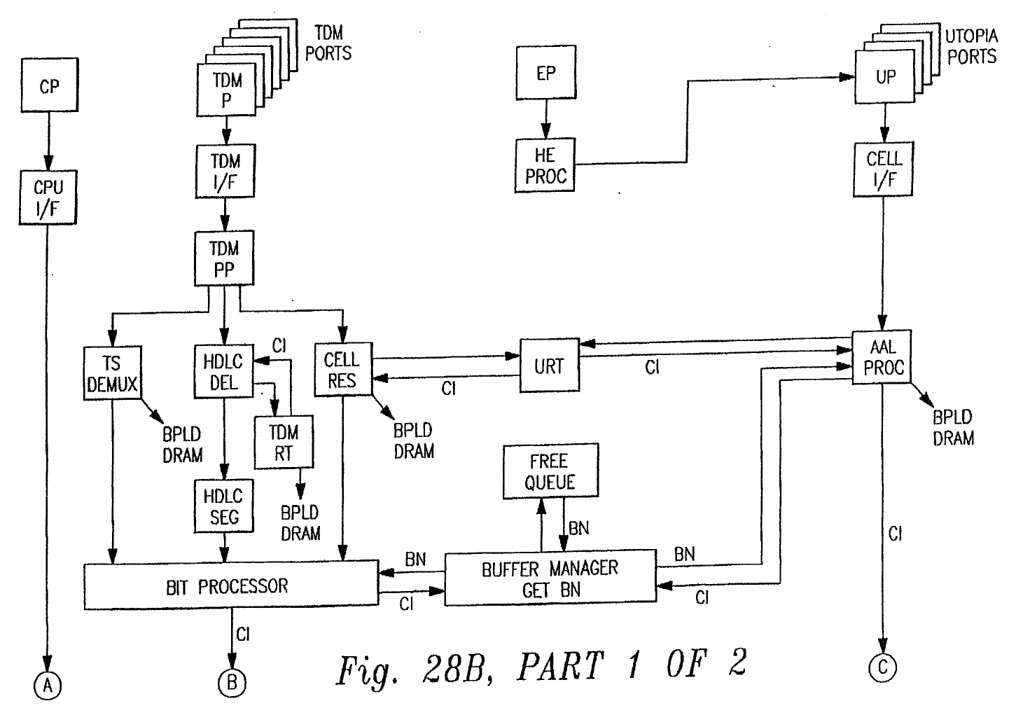

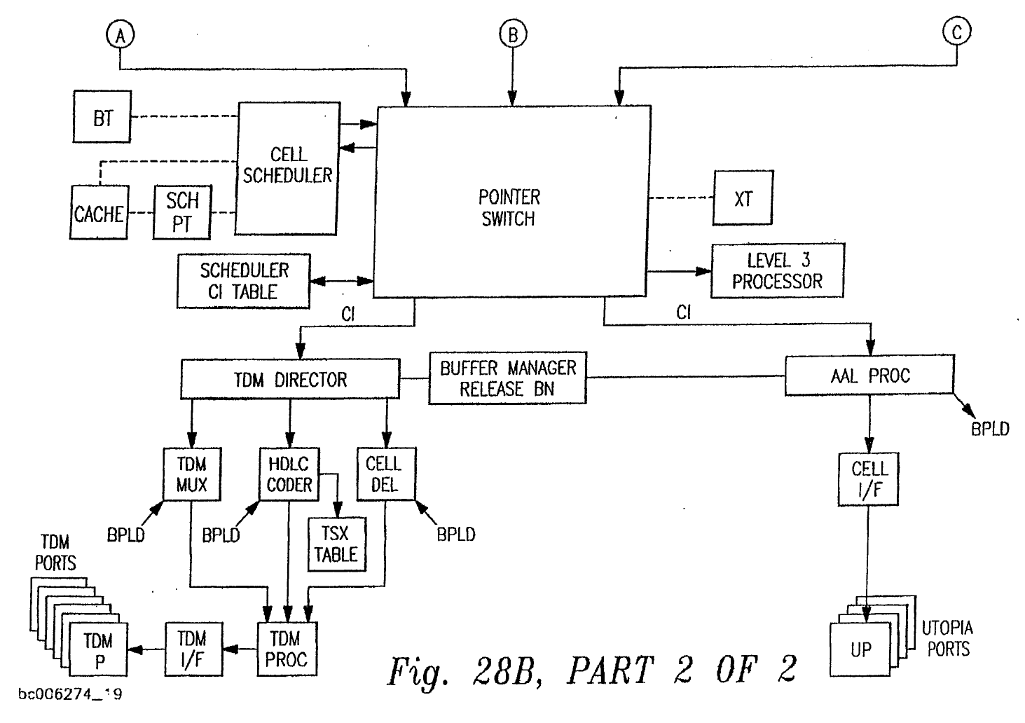

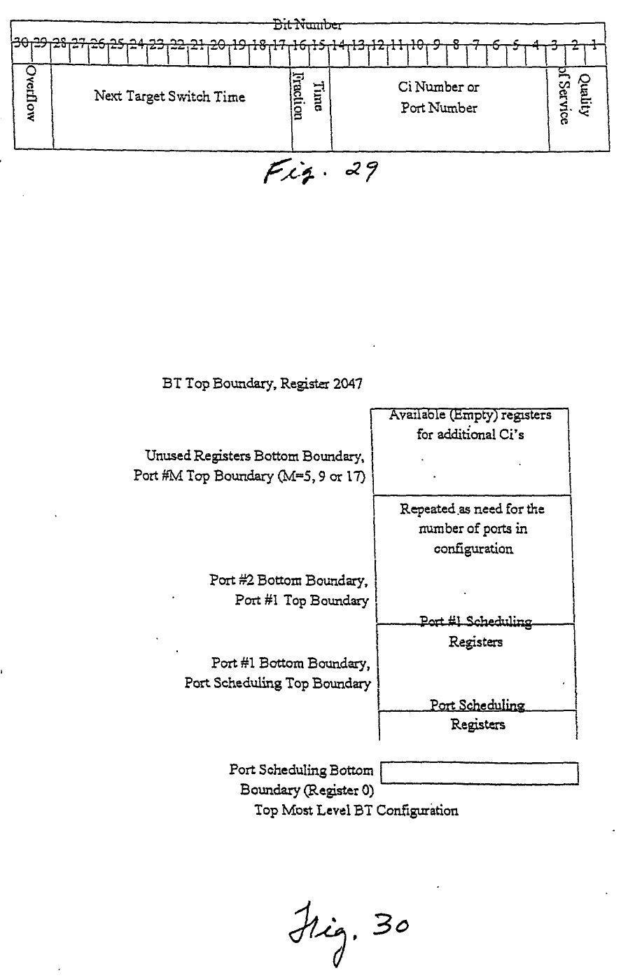

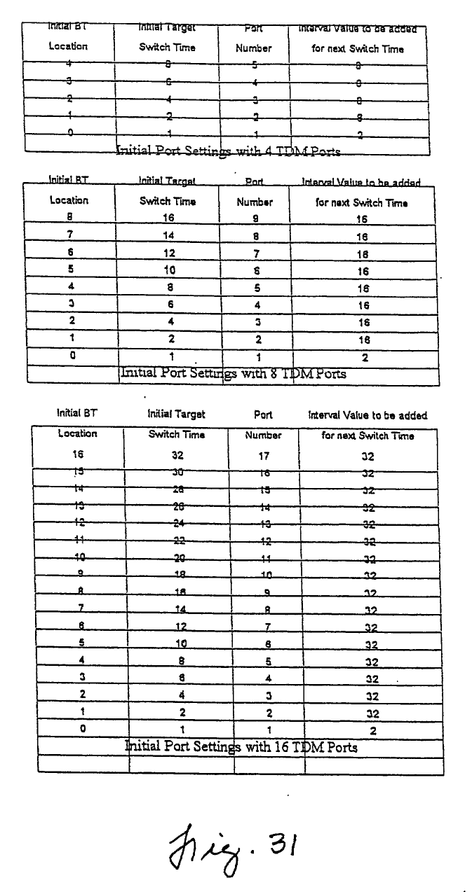

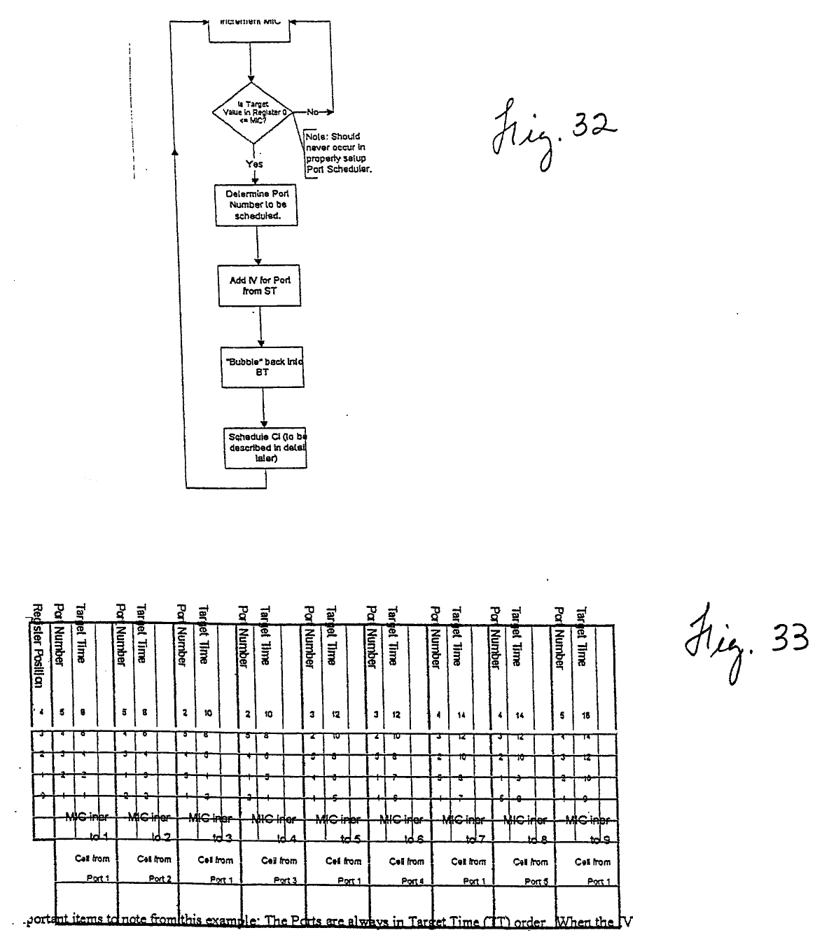

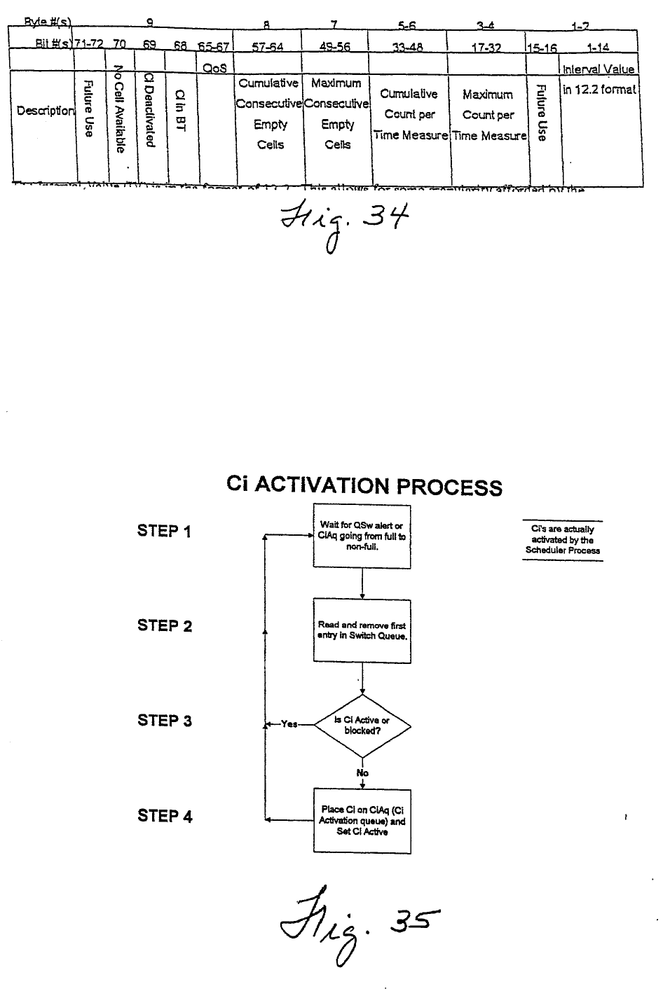

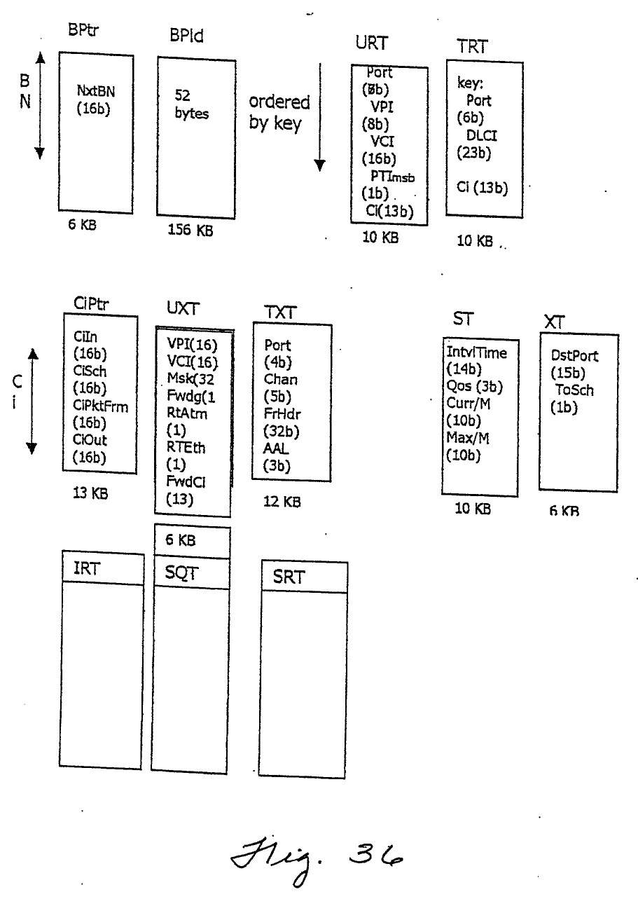

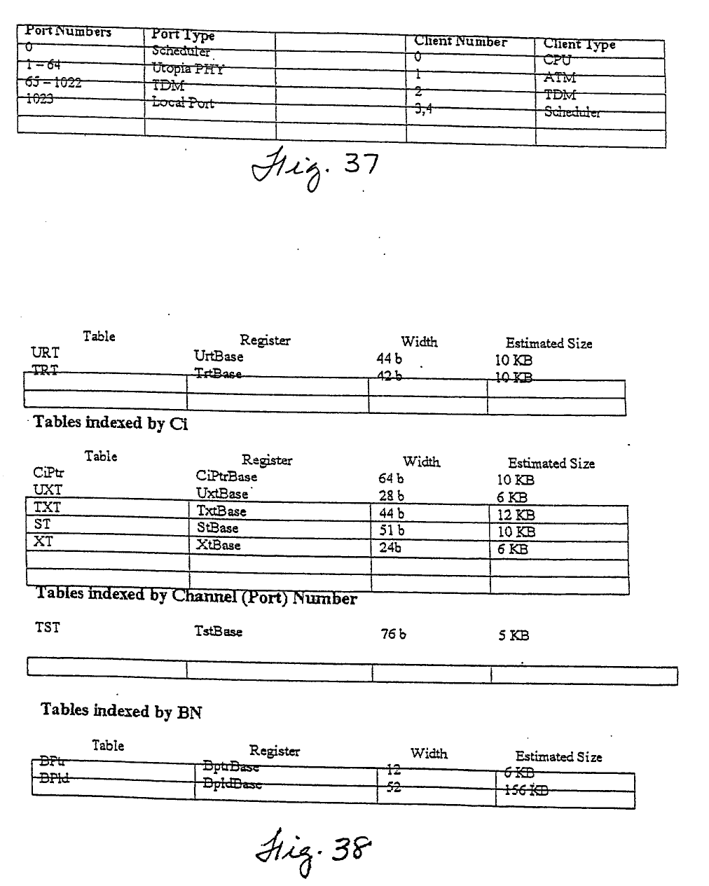

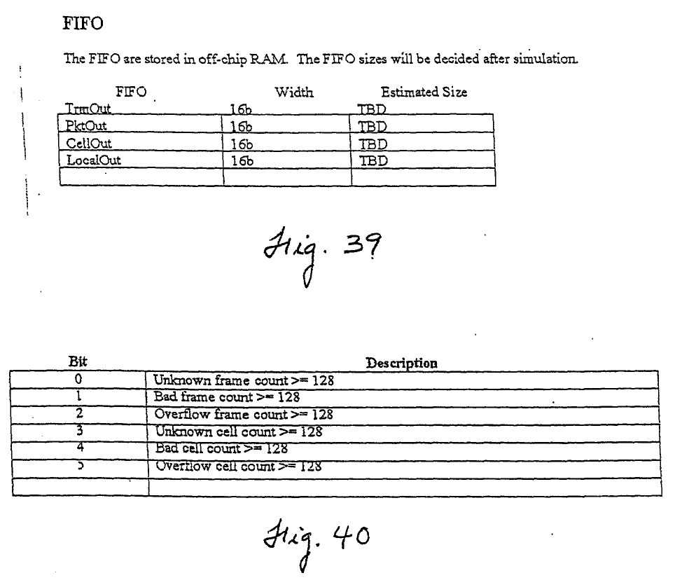

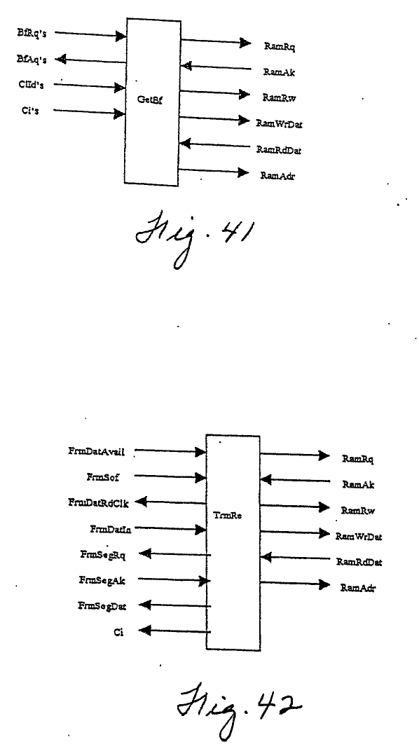

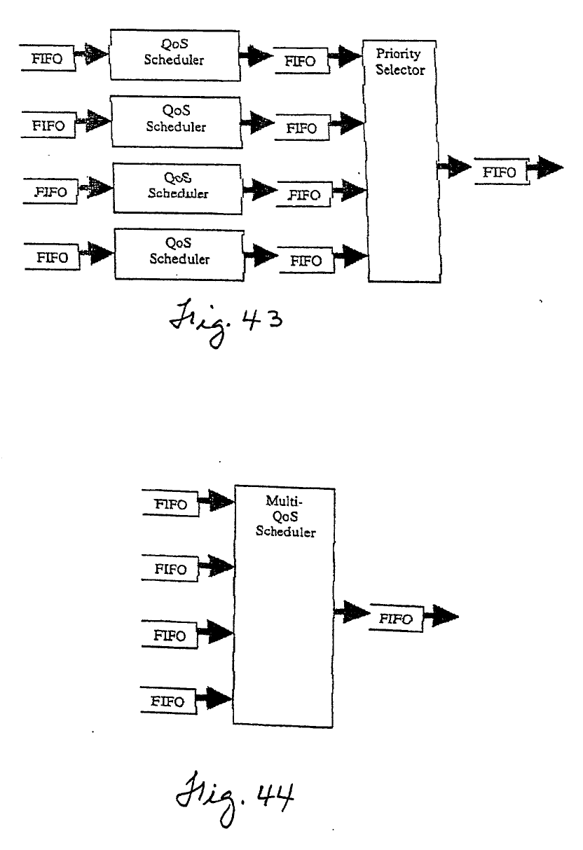

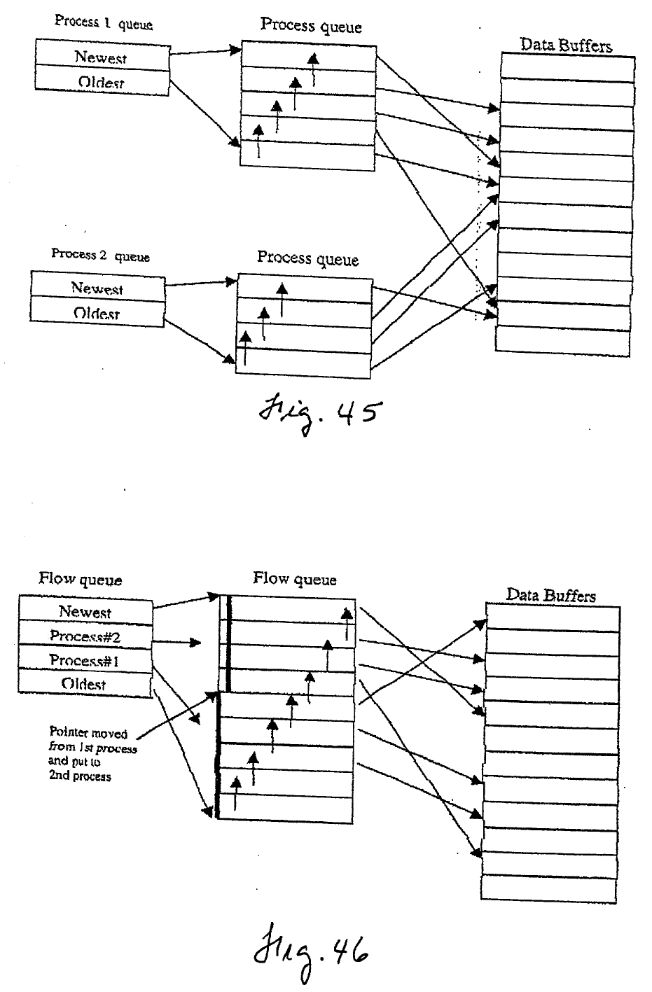

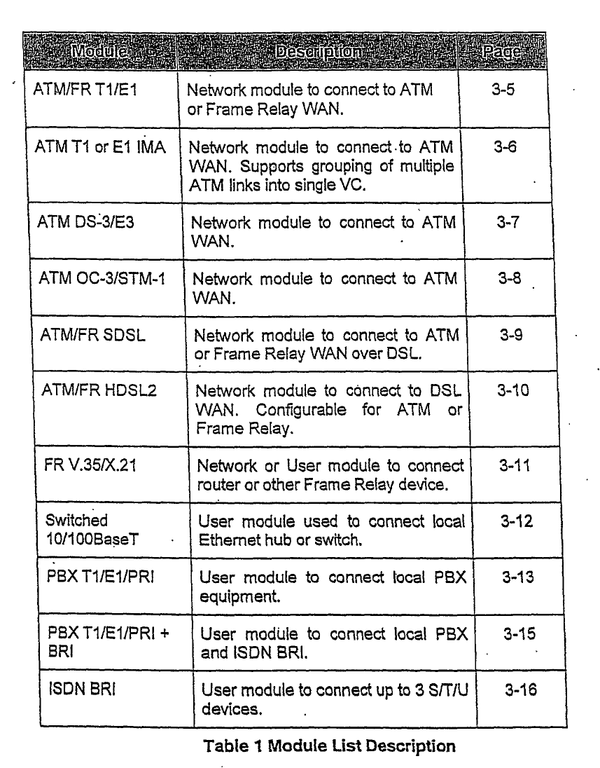

FIG. 11 is a schematic view similar to that of FIG. 8, but showing additional networks and devices interfaced with the device of FIG. 8.

FIG. 12 is a front panel view of an ATM/FR T1/E1 Interface Module according to the present invention.

FIG. 13 is a front panel view of an ATM/FR T1/E1 IMA Interface Module according to the present invention.

FIG. 14 is a front panel view of an ATM DS-3/E3 Interface Module according to the present invention.

FIG. 15 is a front panel view of an ATM OC-3/STM-1 Interface Module according to the present invention.

FIG. 16 is a front panel view of an ATM/FR SDSL Interface Module according to the present invention.

FIG. 17 is a front panel view of an ATM HDSL2 Interface Module according to the present invention.

FIG. 18 is a front panel view of an FR V.35/X.21 Interface Module according to the present invention.

FIG. 19 is a front panel view of Switched 10/100 Base T Interface Module according to the present invention.

FIG. 20 is a front panel view of a PBX T1/E1 Interface Module according to the present invention.

FIG. 21 is a front panel view of a PBX T1/E1/PRI+BRI Interface Module according to the present invention.

FIG. 22 is a front panel view of a ISDN BRI Interface Module according to the present invention.

FIG. 23 is a diagrammatic view showing Inverse Multiplexing (IMA) logic flow implemented in the device of FIG. 1.

FIG. 24 is a diagrammatic view showing network interworking mapping implemented in the device of FIG. 1.

FIG. 25 is a diagrammatic view showing service interworking mapping implemented by the device of FIG. 1.

FIG. 26 is a diagrammatic view showing the device of FIG. 1 interfaced with various networks and PBXs to form CES-based voice connections.

FIG. 27 is a view similar to that of FIG. 25, but showing AAL-2 based voice connections.

FIG. 28A is a simplified block diagram of an Application Specific Integrated Circuit (ASIC) module comprising part of the device of FIG. 1, which is operably interconnected with other components of the device.

FIG. 28B is a more detailed version of the block diagram of FIG. 28A.

FIG. 29 is a table showing contents of a bubble register associated with the ASIC of FIG. 28.

FIG. 30 is a diagram showing the structure of the register of FIG. 29.

FIG. 31 is a table showing the arrangement of port scheduling registers of the device of FIG. 1.

FIG. 32 is a flow chart showing port scheduling of the device of FIG. 1.

FIG. 33 is a table illustrating operation of the port scheduling portion of the bubble table of the device of FIG. 1.

FIG. 34 is a table illustrating operation of the scheduler table function of the device of FIG. 1.

FIG. 35 is a flow chart illustrating a Ci (Connection Index) activation process implemented by the device of FIG. 1.

FIG. 36 is a diagrammatic view of data structures of the device of FIG. 1.

FIG. 37 is a table indicating assignments of port numbers for the device of FIG. 1.

FIG. 38 is a group of 4 tables illustrating logical organization of the apparatus of FIG. 1.

FIG. 39 is a table showing FIFO sizes for the device of FIG. 1.

FIG. 40 is a table showing the organization of an IN STAT register for the device of FIG. 1.

FIG. 41 is a block diagram of a Cell Pointer block of the device of FIG. 1.

FIG. 42 is a block diagram of a Tdm Resolution block of the device of FIG. 1.

FIG. 43 is a block diagram showing a prior art scheduler for multiple qualities of service.

FIG. 44 is a block diagram showing a single scheduler to fully service multiple qualities of service according to the present invention.

FIG. 45 is a flow chart showing prior art multiple queues associated with a buffer pool.

FIG. 46 is a flow chart showing a Beaded Buffer Pointer Chain With Intermediate Pointers according to the present invention.

Table 1 is a list of Interface Modules useable in the device of FIG. 1.

### DESCRIPTION OF THE PREFERRED EMBODIMENTS

1. Overview: (Product Specification MAKO-Dexter—3000, pp. 1-6, Revised 1.0.0.)

2. 2-Page Dexter 3000 Integrated Access Device Data Sheet.

3. 1-page Dexter 3000 Interface Module, T1 and E1 IMA.

4. 1-page Dexter 3000 Interface Module, Synchronous Serial.

5. Product Guide

a. Chapter 2. Introduction.

b. Chapter 3. Features and components.

c. Chapter 4. Functional description.

d. Chapter 5. Standards compliance.

e. 1-page index

In the description of the invention titled “Integrated Access Device For Asynchronous Transfer Mode ATM Communications” contained in this specification, the invention is sometimes referred to as a Dexter 3000 IAD (Integrated Access Device), or Dexter. The Integrated Access Device for ATM according to the present invention includes an integrated circuit module which comprises an array of logic gates and flip-flops which are interconnected to form a cell switching fabric. The cell switching fabric functions in cooperation with other components of the Integrated Access Device to segment and re-assemble cell queues, and includes a cell forwarding architecture that implements a cell scheduler function. This Integrated Circuit Module is preferably an Application Specific Integrated Circuit (ASIC) but may optionally be a Programmable Logic Array (PLA). In this specification, the integrated circuit which contains the cell switching fabric is referred to interchangeably as MAKO or eXpedite™ processor.

6. Operation of the Invention.

(a) Product Specification MAKO

(b) Scheduler High Level Information. Pp. 1-15.

(c) Further Identified Aspects of the Invention.

1. A Single Scheduler to Fully Service Multiple Qualities of Service.

2. Algorithm to Assign Scheduler Resources to Multiple Ports in Correct Proportions.

3. Beaded Buffer Pointer Chain With Intermediate Pointers.

4. Fractional Interval Times for Fine Granularity Bandwidth Allocation.

5. Multiple Preemptive CBR's for Precise Port Pacing Control.

6. Partitionable Page Shifter With Self-Timing Xor Chain.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

It is claimed:

1. A method for scheduling data parcels from at least one client process to be output for transmission over a first communication line, the first communication line having an associated first bit rate, the at least one client process including a first client process having an associated second bit rate, the method comprising:
identifying, at a scheduler, a plurality of client data parcels associated with the first client process;
scheduling selected client data parcels to be included in an output stream provided to physical layer logic for transmission over the first communication line;
determining an appropriate ratio of filler data parcels to be inserted into the output stream, said filler data parcels including non-meaningful data; and
generating the output stream;
wherein the output stream includes client data parcels and filler data parcels.

2. The method of claim 1 wherein said determining includes determining an appropriate ratio of filler data parcels to be inserted into the output stream to thereby cause a bit rate of the output stream to be substantially equal to the first bit rate.

3. The method of claim 1 wherein the output stream includes a uniform pattern of client data parcels and filler data parcels.

4. The method of claim 1 wherein the output stream includes a uniform pattern of client data parcels and filler data parcels; and
wherein the method further comprises repeating the uniform pattern of client data parcels and filler data parcels on a periodic basis.

5. The method of claim 1 wherein the physical layer logic includes an output transmitter adapted to transmit data parcels over the first communication line.

6. The method of claim 1 further comprising continuously transmitting a continuous stream bits over the first communication line during normal operation of the communication line.

7. The method of claim 1 wherein the first communication line corresponds to a communication line utilizing an ATM protocol; and
wherein the filler data parcels correspond to ATM idle cells.

8. The method of claim 1 wherein the first communication line corresponds to a communication line utilizing a frame relay protocol; and
wherein the filler data parcels correspond to disposable frames which include predefined flag bytes.

9. The method of claim 1 wherein the data parcels correspond to data parcels selected from a group consisting of ATM cells, frame relay frames, and IP packets.

10. The method of claim 1 wherein said scheduling includes prioritizing client data parcels based upon quality of service (QoS) parameters associated with each client data parcel.

11. The method of claim 1 wherein the scheduling operations are performed by the scheduler without the use of an internal clock source.

12. The method of claim 1 wherein the scheduling operations performed by the scheduler are not based on an internal time reference.

13. The method of claim 1 wherein the at least one client process further includes a second client process having an associated third bit rate different from that of the second bit rate; and
wherein the method further comprises:
identifying incoming client data parcels from the second client process; and
wherein the output data stream further includes client data parcels from the second client process.

14. A computer program product for scheduling data parcels from at least one client process to be output for transmission over a first communication line, the first communication line having an associated first bit rate, the at least one client process including a firs client process having an associated second bit rate, the computer program product comprising:
a computer usable medium having computer readable code embodied therein, the computer readable code comprising:
computer code for identifying a plurality of client data parcels associated with the first client process;
computer code for scheduling selected client data parcels to be included in an output stream to be provided to physical layer logic for transmission over the first communication line;
computer code for determining an appropriate ratio of filler data parcels to be inserted into the output stream, said filler data parcels including non-meaningful data; and
computer code for generating the output stream;
wherein the output stream includes client data parcels and filler data parcels.

15. The computer program product of claim 14 wherein said determining computer code includes computer code for determining an appropriate ratio of filler data parcels to be inserted into the output stream to thereby cause a bit rate of the output stream to be substantially equal to the first bit rate.

16. The computer program product of claim 14 wherein the output stream includes a uniform pattern of client data parcels and filler data parcels.

17. The computer program product of claim 14 wherein the output stream includes a uniform pattern of client data parcels and filler data parcels; and
wherein the computer program product further comprises repeating the uniform pattern of client data parcels and filler data parcels on a periodic basis.

18. The computer program product of claim 14 wherein the physical layer logic includes an output transmitter adapted to transmit data parcels over the first communication line.

19. The computer program product of claim 14 further comprising computer code for continuously transmitting a continuous stream bits over the first communication line during normal operation of the communication line.

20. The computer program product of claim 14 wherein the first communication line corresponds to a communication line utilizing an ATM protocol; and
wherein the filler data parcels correspond to ATM idle cells.

21. The computer program product of claim 14 wherein the first communication line corresponds to a communication line utilizing a frame relay protocol; and
wherein the filler data parcels correspond to disposable frames which include predefined flat bytes.

22. The computer program product of claim 14 wherein the data parcels correspond to data parcels selected from a group consisting of ATM cells, frame relay frames, and IP packets.

23. The computer program product of claim 14 wherein said scheduling computer code includes computer code for prioritizing client data parcels based upon quality of service (QoS) parameters associated with each client data parcel.

24. The computer program product of claim 14 wherein the scheduling operations performed by the scheduling computer code are not preferred using an internal time reference signal.

25. The computer program product of claim 14 wherein the at least one client process further includes a second client process having an associate third bit rate different from that of the second bit rate; and
wherein the computer program product further comprises computer code for identifying incoming client data parcels from the second client process; and
wherein the output data stream further includes client data parcels from the second client process.

26. A system for scheduling data parcels from at least one client process to be output for transmission over a first communication line, the first communication line having an associated first bit rate, the at least one client process including a first client process having an associated second bit rate, the system comprising:
a scheduler adapted to identify incoming client data parcels from the first client process, and to generate an output stream of data parcels to be provided to physical layer logic for transmission over the first communication line;
the scheduler being configured to designed to generate filler data parcels which include non-meaningful data;
the scheduler being further configured or designed to determine and appropriate ratio of filler data parcels to be inserted into the scheduler output stream.

27. The system of claim 26 wherein the scheduler is further configured or designed to determine an appropriate ratio of filler data parcels to be inserted into the scheduler output stream to thereby cause a bit rate of the scheduler output stream to be substantially equal to the first bit rate.

28. The system of claim 26 wherein the scheduler output stream includes both client data parcels which include meaningful data and filler data parcels which do not include meaningful data.

29. The system of claim 26 wherein the scheduler output stream includes a uniform pattern of client data parcels and filler data parcels.

30. The system of claim 26 wherein the scheduler output stream includes a uniform pattern of client data parcels and filler data parcels, the uniform pattern being repeated on a periodic basis.

31. The system of claim 26 wherein the physical layer logic includes an output transmitter adapted to transmit data parcels over the first communication line.

32. The system of claim 26 wherein the first communication line is adapted to utilize a communication protocol which requires a continuous stream of bits to be transmitted over the first communication line during normal operation of the communication line.

33. The system of claim 26 wherein the first communication line corresponds to a communication line utilizing an ATM protocol; and
wherein the filler data parcels correspond to ATM idle cells.

34. The system of claim 26 wherein the first communication line correspond to a communication line utilizing a frame relay protocol; and
wherein the filler data parcels correspond to disposable frames which include predefined flag bytes.

35. The system of claim 26 wherein the data parcels correspond to data parcels selected from a group consisting of ATM cells, frame relay frames, and IP packets.

36. The system of claim 26 further comprising:
quality of service (QoS) scheduling logic;
ratio computation component (RCC) logic in communication with the QoS scheduling logic, the RCC logic being configured or designed to compute an appropriate ratio of meaningful data parcels to non-meaningful data parcels.

37. The system of claim 26 wherein the scheduler is devoid of an internal clock source.

38. The system of claim 26 wherein the scheduling operations performed by the scheduler are not based on an internal time reference.

39. The system of claim 26 wherein the at least one client process further includes a second client process having an associated third bit rate different from that of the second bit rate; and
wherein the scheduler is further adapted to identify incoming client data parcels from the second client process, and to generate an output stream of data parcels to physical layer logic for transmission over the first communication line;
wherein the output data stream includes client data parcels from the first and second client processes.

40. A scheduler for scheduling data parcels from at least one client process to be output for transmission over a first communication line, the first communication line having an associated first bit rate, the at least one client process including a first client process having an associated second bit rate;
the scheduler being adapted to identify incoming client data parcels from the first client process, and to generate an output stream of data parcels to physical layer logic for transmission over the first communication line;
the scheduler being configured or designed to generate filler data parcels which include non-meaningful data.

41. The scheduler of claim 40 wherein the scheduler is devoid of an internal clock source.

42. The scheduler of claim 40 wherein the scheduler includes an ATM cell switch.

43. The scheduler of claim 40 further comprising:
quality of service (QoS) scheduling logic;
ratio computation component (RCC) logic in communication with the QoS scheduling logic, the RCC logic being configured or designed to compute an appropriate ratio of meaningful data parcels to non-meaning data parcels.

44. A system for scheduling data parcels from at least one client process to be output for transmission over a first communication line, the first communication line having an associated first bit rate, the at least one client process including a first client process having an associated second bit rate, the system comprising:
means for identifying a plurality of client data parcels associated with the first client process;
scheduling means in communication with the identifying means for scheduling selected client data parcels to be included in an output stream to be provided to physical layer logic for transmission over the first communication line;
means for determining an appropriate ratio of filler data parcels to be inserted into the output stream, said filler data parcels including non-meaningful data; and
means for generating the output stream;
wherein the output stream includes client data parcels and filler data parcels.

45. The system of claim 44 wherein said determining means includes means for determining an appropriate ratio of filler data parcels to be inserted into the scheduling means output stream to thereby cause a bit rate of the output stream to be substantially equal to the first bit rate.

46. The system of claim 44 wherein the output stream includes a uniform pattern of client data parcels and filler data parcels.

47. The system of claim 44 wherein the output stream includes a uniform pattern of client data parcels and filler data parcels; and
wherein the system further comprises repeating the uniform pattern of client data parcels and filler data parcels on a periodic basis.

48. The system of claim 44 wherein the physical layer logic includes an output transmitter adapted to transmit data parcels over the first communication line.

49. The system of claim 44 further comprising means for continuously transmitting a continuous stream bits over the first communication line during normal operation of the communication line.

50. The system of claim 44 wherein the first communication line corresponds to a communication line utilizing an ATM protocol; and
wherein the filler data parcels correspond to ATM idle cells.

51. The system of claim 44 wherein the first communication line corresponds to a communication line utilizing a frame relay protocol; and
wherein the filler data parcels correspond to disposable frames which include predefined flag bytes.

52. The system of claim 44 wherein the data parcels correspond to data parcels selected from a group consisting of ATM cells, frame relay frames, and IP packets.

53. The system of claim 44 wherein said scheduling means includes means for prioritizing client data parcels based upon quality of service (QoS) parameters associated with each client data parcel.

54. The system of claim 44 wherein the scheduling means is devoid of an internal clock source.

55. The system of claim 44 wherein the scheduling operations performed by the scheduling means are not based on an internal time reference.

56. The system of claim 44 wherein the at least one client process further includes a second client process having an associated third bit rate different from that of the second bit rate; and
wherein the system further comprises means for identifying incoming client data parcels from the second client process; and
wherein the output data stream further includes client data parcels from the second client process.

57. A system for scheduling data parcels from at least one client process to be output for transmission over a first communication line, the first communication line having an associated first bit rate, the at least one client process including a first client process having an associated second bit rate, the system comprising:
means for identifying a plurality of client data parcels associated with the first client process;
means for scheduling selected client data parcels to be included in an output stream to be provided to physical layer logic for transmission over the first communication line;
means for determining an appropriate ratio of filler data parcels to be inserted into the output stream, said filler data parcels including non-meaningful data; and
means for generating the output stream;
wherein the output stream includes client data parcels and filler data parcels.

58. The system of claim 57 wherein said determining computer code includes means for determining an appropriate ratio of filler data parcels to be inserted into the output stream to thereby cause a bit rate of the output stream to be substantially equal to the first bit rate.

59. The system of claim 57 wherein the output stream includes a uniform pattern of client data parcels and filler data parcels.

60. The system of claim 57 wherein the output stream includes a uniform pattern of client data parcels and filler data parcels; and
wherein the system further comprises repeating the uniform pattern of client data parcels and filler data parcels on a periodic basis.

61. The system of claim 57 wherein the physical layer logic includes an output transmitter adapted to transmit data parcels over the first communication line.

62. The system of claim 57 further comprising means for continuously transmitting a continuous stream bits over the first communication line during normal operation of the communication line.

63. The system of claim 57 wherein the first communication line corresponds to a communication line utilizing an ATM protocol; and
wherein the filler data parcels correspond to ATM idle cells.

64. The system of claim 57 wherein the first communication line corresponds to a communication line utilizing a frame relay protocol; and
wherein the filler data parcels correspond to disposable frames which include predefined flag bytes.

65. The system of claim 57 wherein the data parcels correspond to data parcels selected from a group consisting of ATM cells, frame relay frames, and IP packets.

66. The system of claim 57 wherein said scheduling computer code includes means for prioritizing client data parcels based upon quality of service (QoS) parameters associated with each client data parcel.

67. The system of claim 57 wherein the scheduling operations performed by the scheduling computer code are not performed using an internal time reference signal.

68. The system of claim 57 wherein the at least one client process further includes a second client process having an associated third bit rate different from that of the second bit rate; and
wherein the system further comprises means for identifying incoming client data parcels from the second client process; and
wherein the output data stream further includes client data parcels from the second client process.
